(19) United States
(12) Patent Application Publication
(10) Pub. No.: US 2015/0177879 A1
(43) Pub. Date: Jun. 25, 2015

(54) TOUCH PANEL AND METHOD OF MANUFACTURING TOUCH PANEL

(71) Applicant: Sharp Kabushiki Kaisha, Osaka-shi, Osaka (JP)

(72) Inventor: Katsunori Misaki, Yonago-shi (JP)

(21) Appl. No.: 14/416,117

(22) PCT Filed: Jul. 26, 2013
(86) PCT No.: PCT/JP2013/070353

§ 371 Date: Jan. 21, 2015

(30) Foreign Application Priority Data
Jul. 31, 2012 (JP) 2012-170546

(51) Int. Cl. G06F 3/044; B29C 59/00; G06F 1/16

(52) U.S. Cl. CPC G06F 3/044; G06F 1/16; B29C 59/00; G06F 2203/04111; G06F 2203/04103; G06F 2203/04107

(57) ABSTRACT

A method of manufacturing a touch panel with a reduced number of steps is provided. A method of manufacturing a touch panel (1) includes the steps of; patterning a first transparent conductive film to form a layer containing parts of sensor electrodes (14), (15); patterning a highly-conductive film having a lower electric resistance than the first transparent conductive film to form a layer containing lines (171); patterning a light-shielding film to form a layer containing a light-shielding portion (11); and, after forming the layer containing the light-shielding portion (11), pattering an insulating film to form a layer containing interlayer insulating films (121) and planarizing film (122). The step of patterning a light-shielding film and the step of patterning an insulating film are performed between the step of pattering a first transparent conductive film and the step of patterning a highly-conductive film.

### TECHNICAL FIELD

The present invention relates to a touch panel and a method of manufacturing a touch panel, and more particularly to a cover glass-integrated touch panel and a method of manufacturing such a touch panel.

### BACKGROUND ART

A touch panel is attached to a cover glass or cover film before being used. When a touch panel is attached to a cover glass, air bubbles may be produced or foreign substances may be introduced, which may reduce yield.

A known cover glass-integrated touch panel includes sensor electrodes provided on the back side of the cover glass (i.e. the side of the glass opposite the operation side). In this arrangement, the substrate of the touch panel also serves as a cover glass (or cover film).

JP 2011-90443 A describes a projected capacitive touch panel including one transparent substrate, where electrodes extending in a first direction and electrodes extending in a second direction that crosses the first direction are provided on one side of the transparent substrate, and a black mask (i.e. light-shielding portion) made of a light-shielding material is provided on the peripheral portions of the transparent substrate.

The black mask may be provided, for example, so as to hide from the viewer the routed lines for electrodes and connecting parts for signal processing provided on the peripheral portions of the transparent substrate. The use of a pigment-type color filter material for the black mask is disclosed.

### DISCLOSURE OF THE INVENTION

As discussed above, it is known to provide a light-shielding film on the non-sensing area of the touch panel and provide lines and the like so as to overlie the light-shielding portion to prevent them from being visible to the user. However, when conductive films that implement sensor electrodes, lines and the like are formed to straddle the border between a region having a light-shielding portion and a region without such a portion, the steps in the light-shielding portion may break off the conductive films. Further, a light-shielding portion with a high surface roughness makes it difficult to form a uniform conductive film on the light-shielding portion. Thus, a planarizing film must be formed for covering the light-shielding portion. However, as a planarizing film must be formed in addition to the light-shielding portion, the number of manufacturing steps increases.

An object of the present invention is to provide a method of manufacturing a touch panel with a reduced number of steps. Another object of the present invention is to provide a touch panel that can be manufactured by a smaller number of steps.

A method of manufacturing a touch panel disclosed herein is a method of manufacturing a touch panel including: sensor electrodes including a first electrode and a second electrode crossing each other in a plan view; an interlayer insulating film insulating the first electrode and the second electrode from each other; lines each electrically connected with one of the sensor electrodes; a light-shielding portion overlying the lines in a plan view; and a planarizing film covering the light-shielding portion, the method including the steps of patterning a first transparent conductive film to form a layer containing parts of the sensor electrodes; patterning a highly-conductive film having a lower electric resistance than the first transparent conductive film to form a layer containing the lines; patterning a light-shielding film to form a layer containing the light-shielding portion; and, after forming the layer containing the light-shielding portion, pattering an insulating film to form a layer containing the interlayer insulating film and the planarizing film. The step of patterning a light-shielding film and the step of patterning an insulating film are performed between the step of pattering a first transparent conductive film and the step of patterning a highly-conductive film.

A touch panel disclosed herein is a touch panel including sensor electrodes including a first electrode and a second electrode crossing each other in a plan view, including: a first transparent conductive layer formed by patterning a first transparent conductive film; a highly-conductive layer formed by patterning a highly-conductive film having a lower electric resistance than the first transparent conductive film; a light-shielding layer formed by patterning a light-shielding film; and an insulating layer formed by patterning an insulating film. The first transparent conductive layer contains parts of the sensor electrodes, and the light-shielding layer and the insulating layer are located between the first transparent conductive layer and the highly-conductive layer.

According to the present invention, a method of manufacturing a touch panel with a reduced number of steps may be obtained. Further, according to the present invention, a touch panel that can be manufactured by a smaller number of steps may be obtained.

### BRIEF DESCRIPTION OF THE DRAWINGS

FIG. 1 is a schematic cross-sectional view of a touch panel-equipped display device according to an embodiment of the present invention.

FIG. 2 is a schematic cross-sectional view of a touch panel-equipped display device according to another embodiment of the present invention.

FIG. 3 is a schematic plan view of a touch panel according to a first embodiment of the present invention.

FIG. 4 shows cross-sections taken along lines A-A′, B-B′, C-C′, D-D′ and E-E′ of FIG. 3.

FIG. 5 is a plan view of one of the X electrodes.

FIG. 6 is a plan view of one of the Y electrodes.

FIG. 7A shows cross-sections illustrating a method of manufacturing the touch panel according to the first embodiment of the present invention.

FIG. 7B shows cross-sections illustrating the method of manufacturing the touch panel according to the first embodiment of the present invention.

FIG. 7C shows cross-sections illustrating the method of manufacturing the touch panel according to the first embodiment of the present invention.

FIG. 7D shows cross-sections illustrating the method of manufacturing the touch panel according to the first embodiment of the present invention.

FIG. 7E shows cross-sections illustrating the method of manufacturing the touch panel according to the first embodiment of the present invention.

FIG. 8 is a schematic plan view of a touch panel according to a first comparative example.

FIG. 9 shows cross-sections taken along lines A-A′, B-B′, C-C′, D-D′ and E-E′ of FIG. 8.

FIG. 10A shows cross-sections illustrating a method of manufacturing the touch panel according to the first comparative example.

FIG. 10B shows cross-sections illustrating the method of manufacturing the touch panel according to the first comparative example.

FIG. 10C shows cross-sections illustrating the method of manufacturing the touch panel according to the first comparative example.

FIG. 10D shows cross-sections illustrating the method of manufacturing the touch panel according to the first comparative example.

FIG. 10E shows cross-sections illustrating the method of manufacturing the touch panel according to the first comparative example.

FIG. 10F shows cross-sections illustrating the method of manufacturing the touch panel according to the first comparative example.

FIG. 10G shows cross-sections illustrating the method of manufacturing the touch panel according to the first comparative example.

FIG. 11 is a schematic plan view of a touch panel according to a second comparative example.

FIG. 12 shows cross-sections taken along lines A-A′, B-B′, C-C′, D-D′ and E-E′ of FIG. 11.

FIG. 13A shows cross-sections illustrating a method of manufacturing the touch panel according to the second comparative example.

FIG. 13B shows cross-sections illustrating the method of manufacturing the touch panel according to the second comparative example.

FIG. 13C shows cross-sections illustrating the method of manufacturing the touch panel according to the second comparative example.

FIG. 13D shows cross-sections illustrating the method of manufacturing the touch panel according to the second comparative example.

FIG. 13E shows cross-sections illustrating the method of manufacturing the touch panel according to the second comparative example.

FIG. 14 is a schematic plan view of a touch panel according to a second embodiment of the present invention.

FIG. 15 shows cross-sections taken along lines A-A′, B-B′, D-D′ and E-E′ of FIG. 14.

FIG. 16 is a schematic plan view of a touch panel according to a third embodiment of the present invention.

FIG. 17 shows cross-sections taken along lines A-A′, B-B′, C-C′, D-D′ and E-E′ of FIG. 16.

FIG. 18A shows cross-sections illustrating a method of manufacturing the touch panel according to the third embodiment of the present invention.

FIG. 18B shows cross-sections illustrating the method of manufacturing the touch panel according to the third embodiment of the present invention.

FIG. 18C shows cross-sections illustrating the method of manufacturing the touch panel according to the third embodiment of the present invention.

FIG. 18D shows cross-sections illustrating the method of manufacturing the touch panel according to the third embodiment of the present invention.

FIG. 18E shows cross-sections illustrating the method of manufacturing the touch panel according to the third embodiment of the present invention.

FIG. 19 is a schematic plan view of a touch panel according to a fourth embodiment of the present invention.

FIG. 20 shows cross-sections taken along lines A-A′, B-B′, D-D′ and E-E′ of FIG. 19.

FIG. 21 is a schematic plan view of a touch panel according to a fifth embodiment of the present invention.

FIG. 22 shows cross-sections taken along lines A-A′, B-B′, C-C′, D-D′ and E-E′ of FIG. 21.

FIG. 23A shows cross-sections illustrating a method of manufacturing the touch panel according to the fifth embodiment of the present invention.

FIG. 23B shows cross-sections illustrating the method of manufacturing the touch panel according to the fifth embodiment of the present invention.

FIG. 23C shows cross-sections illustrating the method of manufacturing the touch panel according to the fifth embodiment of the present invention.

FIG. 23D shows cross-sections illustrating the method of manufacturing the touch panel according to the fifth embodiment of the present invention.

FIG. 23E shows cross-sections illustrating the method of manufacturing the touch panel according to the fifth embodiment of the present invention.

FIG. 23F shows cross-sections illustrating the method of manufacturing the touch panel according to the fifth embodiment of the present invention.

FIG. 24 is a schematic plan view of a touch panel according to a sixth embodiment of the present invention.

FIG. 25 shows cross-sections taken along lines A-A′, B-B′, C-C′, D-D′ and E-E′ of FIG. 24.

FIG. 26A shows cross-sections illustrating a method of manufacturing the touch panel according to the sixth embodiment of the present invention.

FIG. 26B shows cross-sections illustrating the method of manufacturing the touch panel according to the sixth embodiment of the present invention.

FIG. 26C shows cross-sections illustrating the method of manufacturing the touch panel according to the sixth embodiment of the present invention.

FIG. 26D shows cross-sections illustrating the method of manufacturing the touch panel according to the sixth embodiment of the present invention.

FIG. 26E shows cross-sections illustrating the method of manufacturing the touch panel according to the sixth embodiment of the present invention.

FIG. 26F shows cross-sections illustrating the method of manufacturing the touch panel according to the sixth embodiment of the present invention.

FIG. 27 is a schematic plan view of a touch panel according to a seventh embodiment of the present invention.

FIG. 28 shows cross-sections taken along lines A-A′, B-B′, D-D′ and E-E′ of FIG. 27.

FIG. 29 is a schematic plan view of a touch panel according to an eighth embodiment of the present invention.

FIG. 30 shows cross-sections taken along lines A-A′, B-B′, C-C′, D-D′ and E-E′ of FIG. 29.

FIG. 31A shows cross-sections illustrating a method of manufacturing the touch panel according to the eighth embodiment of the present invention.

FIG. 31B shows cross-sections illustrating the method of manufacturing the touch panel according to the eighth embodiment of the present invention.

FIG. 31C shows cross-sections illustrating the method of manufacturing the touch panel according to the eighth embodiment of the present invention.

FIG. 31D shows cross-sections illustrating the method of manufacturing the touch panel according to the eighth embodiment of the present invention.

FIG. 31E shows cross-sections illustrating the method of manufacturing the touch panel according to the eighth embodiment of the present invention.

FIG. 31F shows cross-sections illustrating the method of manufacturing the touch panel according to the eighth embodiment of the present invention.

FIG. 32 is a table listing the constructions of the touch panels of various embodiments of the present invention.

FIG. 33 is a table listing the constructions of the touch panels of various embodiments of the present invention and the constructions of the touch panels of the comparative examples.

### EMBODIMENTS FOR CARRYING OUT THE INVENTION

A method of manufacturing a touch panel according to an embodiment of the present invention is a method of manufacturing a touch panel including: sensor electrodes including a first electrode and a second electrode crossing each other in a plan view; an interlayer insulating film insulating the first electrode and the second electrode from each other; lines each electrically connected with one of the sensor electrodes; a light-shielding portion overlying the lines in a plan view; and a planarizing film covering the light-shielding portion, the method including the steps of: patterning a first transparent conductive film to form a layer containing parts of the sensor electrodes; patterning a highly-conductive film having a lower electric resistance than the first transparent conductive film to form a layer containing the lines; patterning a light-shielding film to form a layer containing the light-shielding portion; and, after forming the layer containing the light-shielding portion, pattering an insulating film to form a layer containing the interlayer insulating film and the planarizing film. The step of patterning a light-shielding film and the step of patterning an insulating film are performed between the step of pattering a first transparent conductive film and the step of patterning a highly-conductive film (first mode).

In the above mode, the planarizing film and interlayer insulating film are formed by a single round of patterning. This will reduce the number of steps (and hence the number of masks) compared with implementations where these are patterned separately.

More specifically, the step of patterning a light-shielding film and the step of patterning an insulating film are performed between the step of patterning a first transparent conductive film and the step of patterning a highly-conductive film. This results in an insulating film formed between a layer formed by patterning the first transparent conductive film and a layer formed by patterning the highly-conductive film. The layer formed by patterning the first transparent conductive film contains some parts of the sensor electrodes. Thus, other parts of the sensor electrodes may be formed with insulating films sandwiched in between. This will insulate the first electrode and the second electrode crossing each other.

Further, in a region that corresponds to the light-shielding portion in a plan view, the films formed by patterning the first transparent conductive film may cross the films formed by patterning the highly-conductive film without a short circuit. Here, the light-shielding portion may be covered with a planarizing film. This will prevent the first transparent conductive film or highly-conductive film from being broken by the steps in the light-shielding portion. Furthermore, even if the light-shielding portion has a high surface roughness, the first transparent conductive film or highly-conductive film may be uniformly formed.

Starting from the first mode, it is preferable that the highly-conductive film includes a metal film and a light-shielding conductive film having a higher optical absorptance than the metal film (second mode).

In the above mode, the highly-conductive film includes a light-shielding conductive film having a high optical absorptance. Thus, the metal film, which has a high reflectance, is less visible.

Starting from the second mode, it is preferable that the light-shielding conductive film is an indium oxide film (third mode).

In the above mode, the metal film and light-shielding conductive film may be etched by the same etchant. This will allow the entire highly-conductive film to be patterned by a signal round.

Starting from any one of the first to third modes, other parts of the sensor electrodes may be formed from the highly-conductive film (fourth mode).

In the above mode, some parts of the sensor electrodes and the lines are formed by a single round of patterning. This will reduce the number of steps compared with implementations where they are patterned separately.

Starting from the fourth mode, the step of patterning a first transparent conductive film, the step of patterning a light-shielding film, the step of patterning an insulating film and the step of patterning a highly-conductive film may be performed in this order (fifth mode).

Starting from the fourth mode, the step of patterning a highly-conductive film, the step of patterning a light-shielding film, the step of patterning an insulating film and the step of patterning a first transparent conductive film may be performed in this order (sixth mode).

Starting from any one of the first to third modes, the step of patterning a second transparent conductive film may further be included, and other parts of the sensor electrodes are formed from the second transparent conductive film (seventh mode).

The above mode will make the sensor electrodes less visible.

Starting from the seventh mode, the step of patterning a second transparent conductive film, the step of patterning a highly-conductive film, the step of patterning a light-shielding film, the step of patterning an insulating film and the step of patterning a first transparent conductive film may be performed in this order (eighth mode).

Starting from the eighth mode, the second electrode may include a plurality of insular electrodes and connecting portions each connecting two adjacent insular electrodes, the first electrode and insular electrodes may be formed from the first transparent conductive film, and the connecting portions may be formed from the second transparent conductive film (ninth mode).

Starting from the eighth mode, the second electrode may include a plurality of insular electrodes and connecting portions each connecting two adjacent insular electrodes, the first electrode and insular electrodes may be formed from the second transparent conductive film, and the connecting portions may be formed from the first transparent conductive film (tenth mode).

Starting from the seventh mode, the step of patterning a first transparent conductive film, the step of patterning a light-shielding film, the step of patterning an insulating film, the step of patterning a second transparent conductive film and the step of patterning a highly-conductive film may be performed in this order (eleventh mode).

A touch panel according to an embodiment of the present invention is a touch panel including sensor electrodes including a first electrode and a second electrode crossing each other in a plan view, including: a first transparent conductive layer formed by patterning a first transparent conductive film; a highly-conductive layer formed by patterning a highly-conductive film having a lower electric resistance than the first transparent conductive film; a light-shielding layer formed by patterning a light-shielding film; and an insulating layer formed by patterning an insulating film. The first transparent conductive layer contains parts of the sensor electrodes, and the light-shielding layer and the insulating layer are located between the first transparent conductive layer and the highly-conductive layer (first arrangement).

Starting from the first arrangement, it is preferable that the highly-conductive film includes a metal film and a light-shielding conductive film having a higher optical absorptance than the metal film (second arrangement).

Starting from the second arrangement, it is preferable that the light-shielding conductive film is an indium oxide film (third arrangement).

Starting from any one of the first to third arrangements, the highly-conductive layer may contain other parts of the sensor electrodes (fourth arrangement).

Starting from any one of the first to third arrangements, a second transparent conductive layer formed by patterning a second transparent conductive film may further be included, and the second transparent conductive layer may contain other parts of the sensor electrodes (fifth arrangement).

### Embodiments

Now, embodiments of the present invention will be described in detail with reference to the drawings. The same or corresponding elements in the drawings are labeled with the same characters and their description will not be repeated. For ease of explanation, the drawings to which reference will be made hereinafter show simplified or schematic representation, or do not show some components. The size ratios of the components shown in the drawings do not necessarily represent the actual size ratios.

### Overall Construction

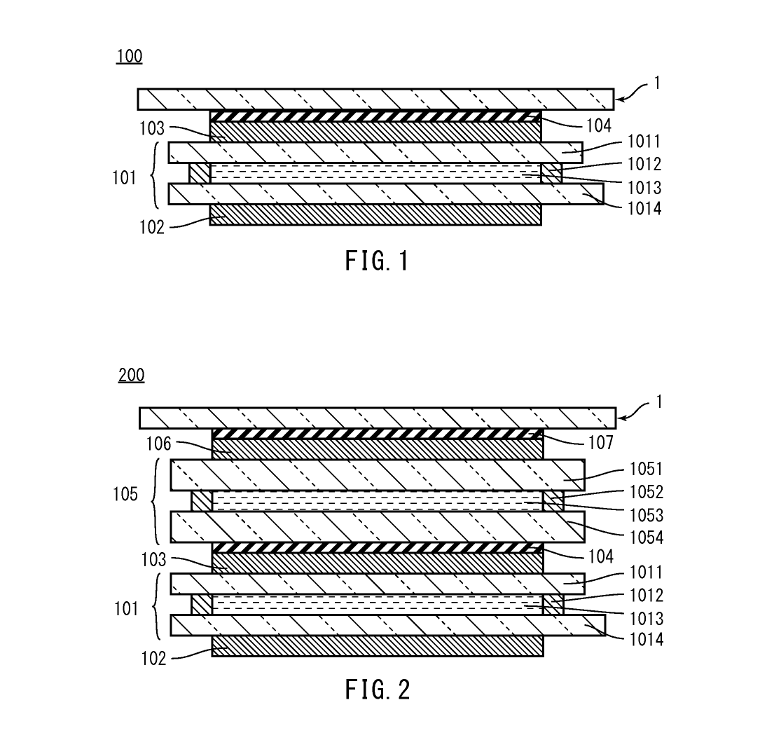

FIG. 1 is a schematic cross-sectional view of a touch panel-equipped display device 100 according to an embodiment of the present invention. The touch panel-equipped display device 100 includes a touch panel 1, a liquid crystal display device 101, polarizers 102 and 103 and a pasting material 104.

The polarizers 102 and 103 are disposed on the opposite sides of the liquid crystal display device 101. The touch panel 1 is attached to the polarizer 103 by means of the pasting material 104.

As described in detail below, the touch panel 1 has sensor electrodes on its side adjacent the liquid crystal display device 101. The sensor electrodes are capable of creating a capacitance between themselves and a finger or the like that is positioned close to the touch panel 1. Based on changes in the capacitance, the touch panel 1 is capable of detecting the location of the finger or the like.

A light-shielding portion is provided on a predetermined area of the touch panel 1. The light-shielding portion hides portions of the panel that one does not wish to be seen by the user. Examples of portions that one does not wish to be seen by the user include lines and terminals of the touch panel 1, or terminals and the like of the liquid crystal display device 101.

The liquid crystal display device 101 includes a color filter substrate 1011, a thin film transistor (TFT) substrate 1014, a seal material 1012 and liquid crystal 1013. A side of the color filter substrate 1011 faces a side of the TFT substrate 1014. The seal material 1012 is provided on the peripheral portions of the color filter substrate 1011 and TFT substrate 1014, and the liquid crystal 1013 is enclosed within.

The TFT substrate 1014 has a greater area than the color filter substrate 1011. Terminals, not shown, are provided on the areas of the TFT substrate 1014 that do not overlie the color filter substrate 1011 when the substrates are attached to each other. These terminals are connected to a drive circuit, not shown, via a flexible printed circuit (FPC), for example.

The TFT substrate 1014 is provided with pixel electrodes and TFTs, not shown. The pixel electrodes and TFTs are arranged in a matrix. The TFTs may be ones that contain amorphous silicon or an In—Ga—Zn—O—based semiconductor; preferably, the TFTs may be ones that contain an In—Ga—Zn—O-based semiconductor, which permits greater electron movement.

The color filter substrate 1011 is provided with color filters and a common electrode, not shown. The color filters are arranged regularly so as to correspond to the pixel electrodes on the TFT substrate 1014. The common electrode is uniformly shaped and present on the active area of the TFT substrate 1014.

The liquid crystal display device 101 may drive the TFTs on the TFT substrate 1014 to create an electric field between an intended pixel electrode and the common electrode in order to control the orientation of the liquid crystal 1013. The liquid crystal display device 101 uses the orientation of the liquid crystal 1013 and the polarizers 102 and 103 to control each pixel to be light transmitting or non-transmitting. This causes an image to be displayed on the liquid crystal display device 101.

The touch panel-equipped display device 100 has been schematically described. In the touch panel-equipped display device 100, the substrate of the touch panel 1 serves as a cover glass or cover film. Thus, it is not necessary to attach an additional cover glass or cover film to the touch panel 1. This simplifies the manufacturing process. It further prevents decrease in yield caused by air bubbles produced or foreign substances introduced when the touch panel 1 were attached to the cover glass or cover film. Further, eliminating elements such as a cover glass reduces the thickness of the liquid crystal display device 101, thereby improving optical transmittance.

FIG. 2 is a schematic cross-sectional view of a touch panel-equipped display device 200 according to another embodiment of the present invention. The touch panel-equipped display device 200 includes, in addition to the components of the touch panel-equipped display device 100, a switch liquid crystal panel 105, a polarizer 106 and a pasting material 107.

The switch liquid crystal panel 105 is attached to the polarizer 103 by means of the pasting material 104. The polarizer 106 is disposed on the side of the switch liquid crystal panel 105 that is opposite the side adjacent the liquid crystal display device 101. The touch panel 1 is attached to the polarizer 106 by means of the pasting material 107.

The switch liquid crystal panel 105 includes a control substrate 1051, a counter-substrate 1054, a seal material 1052 and liquid crystal 1053. A side of the control substrate 1051 faces a side of the counter-substrate 1054. The seal material 1052 is provided on the peripheral portions of the control substrate 1051 and counter-substrate 1054, and the liquid crystal 1053 is enclosed within.

The control substrate 1051 is provided with control electrodes, not shown. The control electrodes are arranged regularly on the control substrate 1051. The counter-substrate 1054 includes a common electrode, not shown. The common electrode is uniformly shaped and present on the active area of the counter-substrate 1054. The switch liquid crystal panel 105 generates an electric field between an intended control electrode and the common electrode to change the orientation of the liquid crystal 1053.

The touch panel-equipped display device 200 switches between 2D display mode and 3D display mode in the following manner:

In 2D display mode, the liquid crystal 1053 of the switch liquid crystal panel 105 is oriented uniformly. As such, an image displayed on the liquid crystal display device 101 is displayed without a change.

In 3D display mode, the switch liquid crystal panel 105 changes the orientation of the liquid crystal 1053 on a regular basis. The changes in orientation causes differences in refractive index, which enable the liquid crystal 1053 to function as a lens. In a manner consistent with this, the touch panel-equipped display device 200 causes the liquid crystal display device 101 to display images that have been captured from multiple directions and include sub-images arranged regularly. The displayed sub-images arranged regularly are separated by the liquid crystal 1053. When the viewer sees the touch panel-equipped display device 200 from an optimum location, different images reach each eye. That is, in 3D display mode, the touch panel-equipped display device 200 achieves 3D displaying using a so-called parallax technique.

The touch panel-equipped display device 200 has been schematically described. In the touch panel-equipped display device 200, too, the substrate of the touch panel 1 serves as a cover glass or cover film.

### Construction of Touch Panel

### First Embodiment

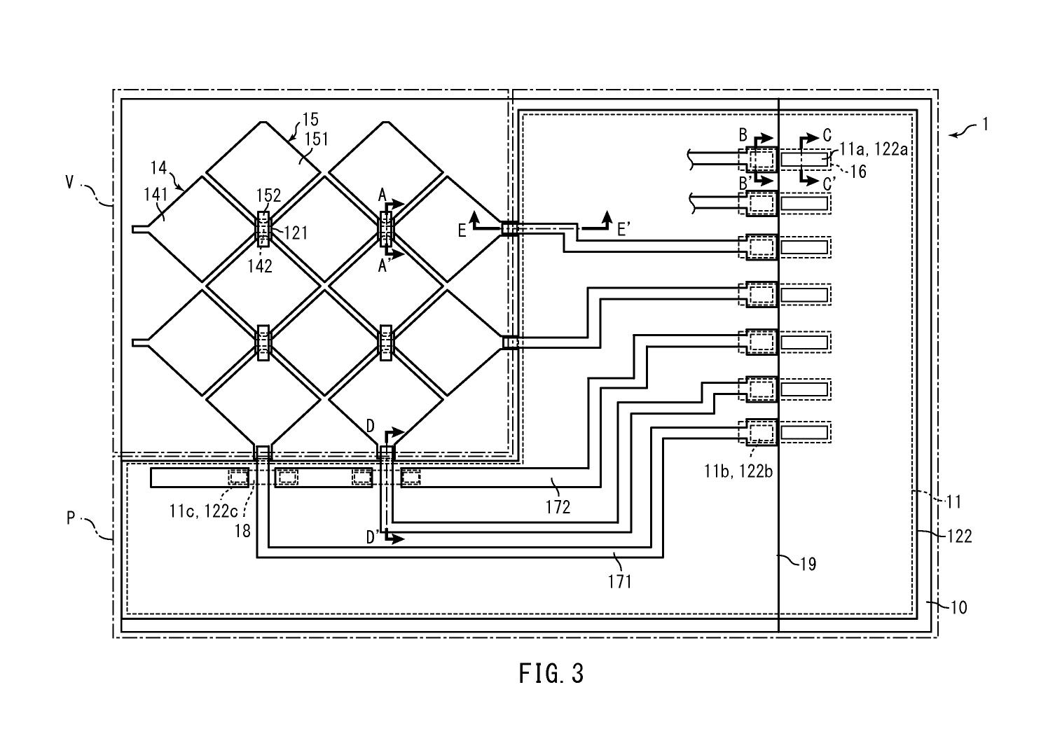

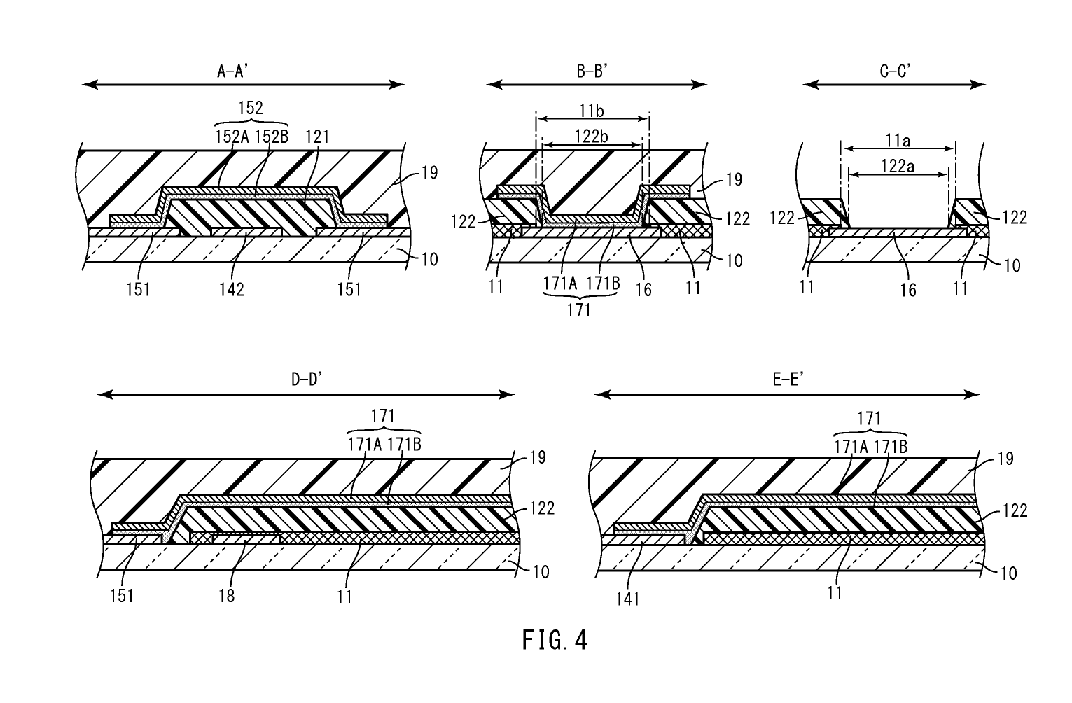

The construction of the touch panel 1 will be described in detail below. FIG. 3 is a schematic plan view of a touch panel 1 according to a first embodiment of the present invention. FIG. 4 shows cross-sections taken along lines A-A′, B-B′, C-C′, D-D′ and E-E′ of FIG. 3.

The touch panel 1 includes a substrate 10, a light-shielding portion 11, interlayer insulating films 121, a planarizing film 122, X electrodes (first electrodes) 14, Y electrodes (second electrodes) 15, terminals 16, lines 171, a ground line 172, relay electrodes 18, and a protection film 19.

The substrate 10 is translucent. The substrate 10 may be, for example, a glass substrate or a transparent resin film. A surface of the substrate 10 may be coated with a passivation film or the like. The light-shielding portion 11, interlayer insulating films 121, planarizing film 122, X electrodes 14, Y electrodes 15, terminals 16, lines 171, ground line 172, relay electrodes 18, and protection film 19 are located on one of the sides of the substrate 10. The touch panel-equipped display device 100 is constructed such that this side is located adjacent the liquid crystal display device 101.

The touch panel 1 includes a sensing area V and a non-sensing area P. The sensing area V is an area of the touch panel 1 that allows a touch by a finger or the like to be detected. That is, the sensing area V is the region having sensor electrodes (X and Y electrodes 14 and 15) provided therein. The sensing area V is not limited to a rectangular region shown in FIG. 3, but may be in any shape. It may even be made up of discontinuous regions. Preferably, the sensing area V is placed over the display region of the liquid crystal display device 101 before being used. Such an arrangement allows the user to input a location relative to an image displayed on the liquid crystal display device 101.

In FIG. 3, the non-sensing area P is disposed to the right of the sensing area V and below it. However, the non-sensing area P may be disposed in any manner. For example, the non-sensing area P may surround the four sides of the sensing area V. Alternatively, the non-sensing area P may be in contact with one side only of the sensing area V.

The light-shielding portion 11 is provided generally over the entire surface of the non-sensing area P. Alternatively, the light-shielding portion 11 may be provided only over portions of the non-sensing area P. The light-shielding portion 11 is capable of blocking light. The light-shielding portion 11 prevents the user from seeing the elements in layers that are more distant from the substrate 10 than the light-shielding portion 11 is.

The light-shielding portion 11 may be formed, for example, by mixing a negative resist with a pigment. As such, edge portions in the pattern of the light-shielding portion 11 are likely to be exposed to an insufficient amount of light, making it difficult to produce a forward-tapered geometry (i.e. a convex cross-section that protrudes away from the substrate 10). Thus, a step may easily form at the boundary between a region where the light-shielding portion 11 is provided and a region where no light-shielding portion is provided (for example, the boundary between the sensing area V and non-sensing area P). Further, the surface roughness of the light-shielding portion 11 depends on the particle size of the pigment. A light-shielding portion 11 with a high surface roughness makes it difficult to form a uniform film on the light-shielding portion 11.

The planarizing film 122 is provided over the light-shielding portion 11. The material of the planarizing film 122 and methods of forming it will be described further below. The planarizing film 122 may be formed in a forward-tapered geometry relatively easily. This will eliminate any steps in the light-shielding portion 11. Further, the planarizing film 122 will make the surface smooth. Thus, even when the light-shielding portion 11 has a high surface roughness, a uniform film may be formed on the planarizing film 122.

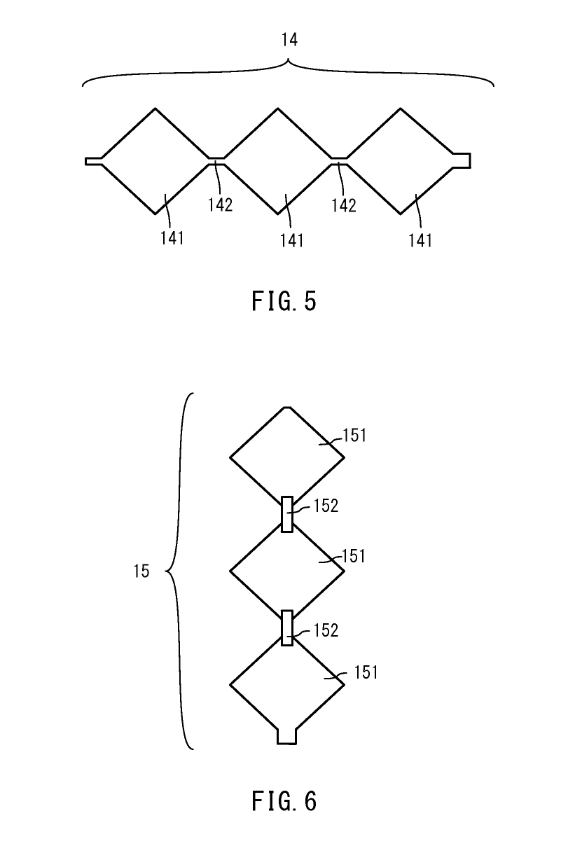

FIG. 5 is a plan view of one of the X electrodes 14. The X electrode 14 includes a plurality of insular electrodes 141 arranged along one direction and connecting portions 142, each connecting portion connecting two adjacent insular electrodes 141.

FIG. 6 is a plan view of one of the Y electrodes 15. The Y electrode 15 includes a plurality of insular electrodes 151 arranged along a direction that crosses the X electrodes 14, and connecting portions 152, each connecting portion connecting two adjacent insular electrodes 151.

The insular electrodes 141 and connecting portions 142 of the X electrodes 14 and the insular electrodes 152 of the Y electrodes 15 are formed of a material that is translucent and electrically conductive. The insular electrodes 141 and 151 and connecting portions 142 are transparent conductive films of indium tin oxide (ITO) or indium zinc oxide (IZO), for example. On the other hand, the connecting portions 152 of the Y electrodes 15 are formed in the same step and from the same material as the lines 171 and ground line 172. The material will be described further below.

Returning to FIGS. 3 and 4, an interlayer insulating film 121 is provided at the intersection of an X electrode 14 and a Y electrode 15. A connecting portion 152 of a Y electrode 15 extends over the interlayer insulating film 121 to connect the two adjacent insular electrodes 151. This arrangement insulates the X and Y electrodes 14 and 15 from each other.

The interlayer insulating films 121 are formed of the same material in the same step as the planarizing film 122, as discussed below.

Terminals 16 are provided in the non-sensing area P. The terminals 16 may be connected to a drive circuit, not shown, via an FPC, for example. To facilitate this, the terminals 16 are not covered by the protection film 19 or other components. Thus, the terminals 16 are preferably formed of a material with a high corrosion resistance. The terminals 16 are formed in the same step and from the same material as the insular electrodes 141 and 151, connecting portions 142 and relay electrodes 18, as discussed further below. Thus, the terminals 16 are transparent conductive films of ITO or IZO, for example.

As shown in FIG. 4, the terminals 16 are located closer to the substrate 10 than the light-shielding portion 11 and planarizing film 122 are. To expose a terminal 16, a contact hole 11a is formed in the light-shielding portion 11 and a contact hole 122a is formed in the planarizing film 122.

A line 171 may electrically connect an X electrode 14 with a terminal 16. A line 171 may also electrically connect a Y electrode 16 with a terminal 16. The ground line 172 is connected with a terminal 15 only, and is not connected with an X electrode 14 or Y electrode 15. The ground line 172 serves as a shield line for shielding electromagnetic noise.

Major sections of the lines 171 and ground line 172 overlie the light-shielding portion 11 and planarizing film 122 in a plan view. As discussed above, this arrangement prevents the major sections of the lines 171 and ground line 172 from being seen by the user. Further, even if the light-shielding portion 11 has a high surface roughness, the planarizing film 122 allows the lines 171 and ground line 172 to be formed uniformly.

A line 171 is in contact with a terminal 16 via a contact hole 11b formed in the light-shielding portion 11 and a contact hole 122b formed in the planarizing film 122. Similarly, the ground line 172 is in contact with a terminal 16 via contact holes 11b and 122b.

A relay electrode 18 is provided at the intersection of a line 171 and the ground line 172 in a plan view. The relay electrodes 18 are formed from the same material and in the same step as the insular electrodes 141 and 151, connecting portions 142 and terminals 16, as discussed above. The relay electrodes 18 are located closer to the substrate 10 than the light-shielding portion 11 and planarizing film 122 are. The ground line 172 is in contact with each relay electrode 18 via a pair of contact holes 11c formed in the light-shielding portion 11 and a pair of contact holes 122c formed in the planarizing film 122. This arrangement allows the ground line 172 to cross the lines 171 in a plan view without a short circuit.

The lines 171 and ground line 172 preferably have a low electric resistance. As discussed above, the lines 171 and ground line 172 are formed of the same material as the connecting portions 152 of the Y electrodes 15. As shown in FIG. 3, some sections of the lines 171 and ground line 172 and the connecting portions 152 do not overlie the light-shielding portion 11 in a plan view. As such, these sections of the lines 171 and ground line 172 and the connecting portions 152 may be visible. Further, those sections of the lines 171 and ground line 172 above which the contact holes 11b and 11c are formed in the light-shielding portion 11 may be visible.

In view of this, as shown in FIG. 4, each of the lines 171 is preferably a laminate including a metal film 171A having a low electric resistance and a light-shielding conductive film 171B having a higher optical absorptance than the metal film 171A. As the line 171 includes a light-shielding conductive film 171B having a high optical absorptance, the line 171 is less visible than a line consisting solely of a metal film 171A, which has a high reflectance. Preferably, the light-shielding conductive film 171B and metal film 171A are deposited in this order away from the substrate 10.

Similarly, the ground line 172 is preferably a laminate including a metal film and a light-shielding conductive film. Again, preferably, the light-shielding conductive film and metal film are deposited in this order away from the substrate 10. Further, each of the connecting portions 152 is also preferably a laminate including a metal film 152A and a light-shielding conductive film 152B. Again, preferably, the light-shielding conductive film 152B and metal film 152A are deposited in this order away the substrate 10.

The light-shielding conductive films 171B and 152B and the light-shielding conductive film of the ground line 172 may be made of a black resin having its conductivity increased by including a high concentration of carbon, for example. More preferably, the light-shielding conductive films 171B and 152B and the light-shielding conductive film of the ground line 172 are indium oxide films. As the light-shielding conductive films 171B and 152B and the light-shielding conductive film of the ground line 172 are indium oxide films, they may be etched at the same time by the same etchant as the metal films 171A and 152A and the metal film of the ground line 172.

The protection film 19 is provided generally over the entire surface of the substrate 10. As discussed above, portions of the terminals 16 are not covered with the protection film 19, i.e. are exposed. The protection film 19 is formed of a translucent insulating material. The protection film 19 may be made of an organic material or an inorganic material.

### Method of Manufacturing Touch Panel 1

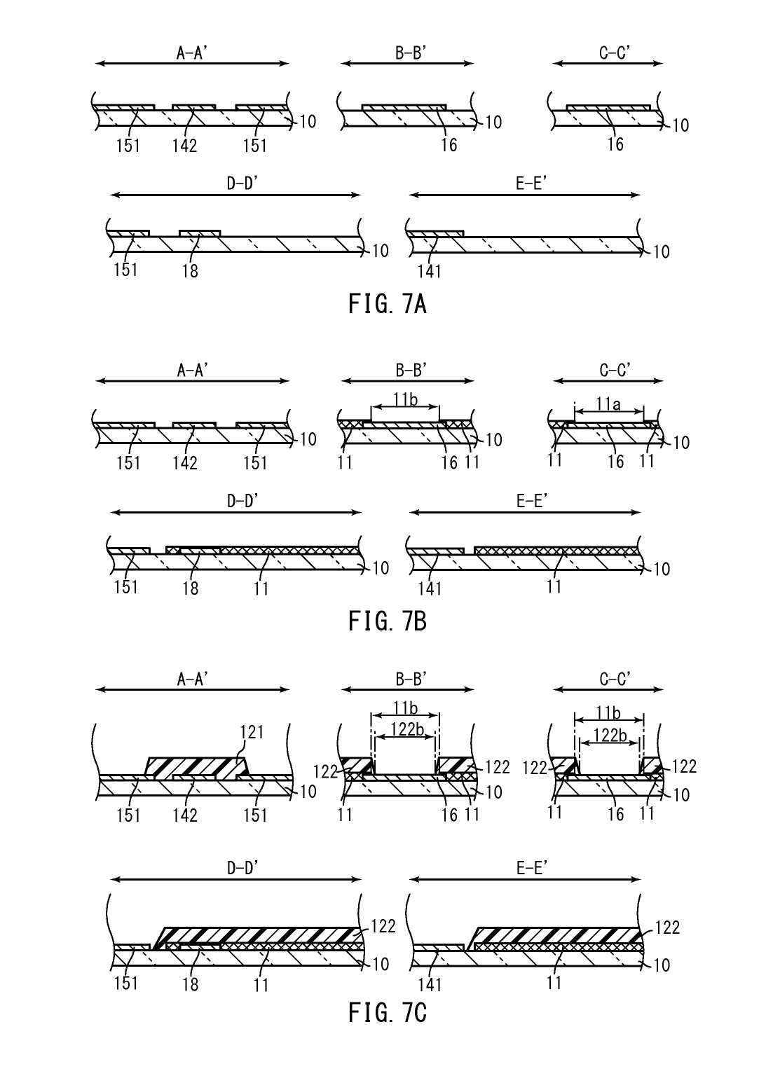

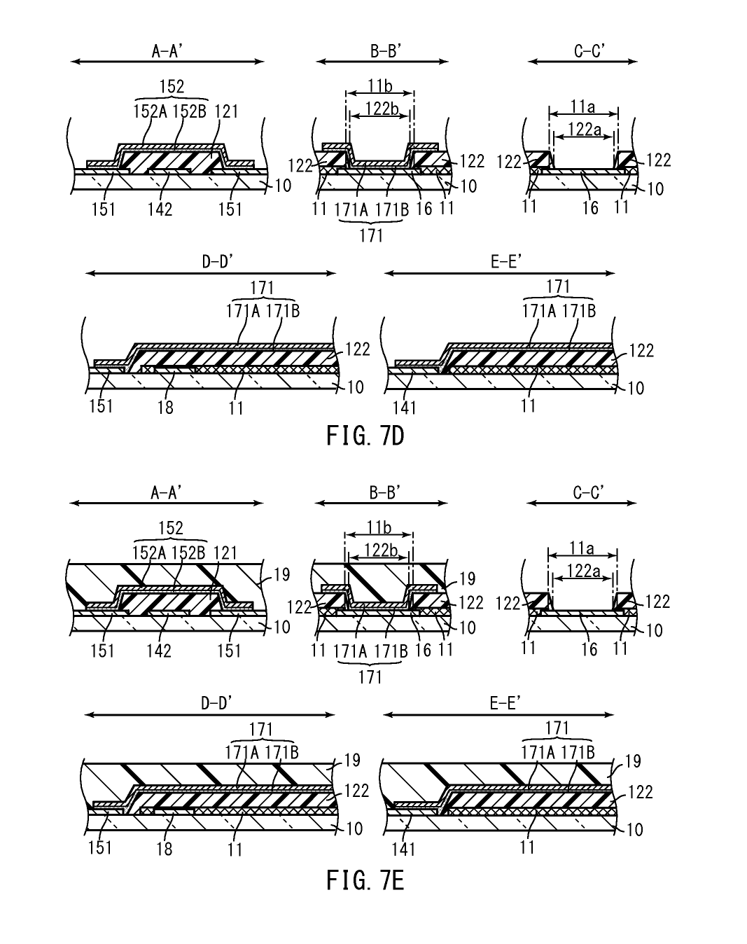

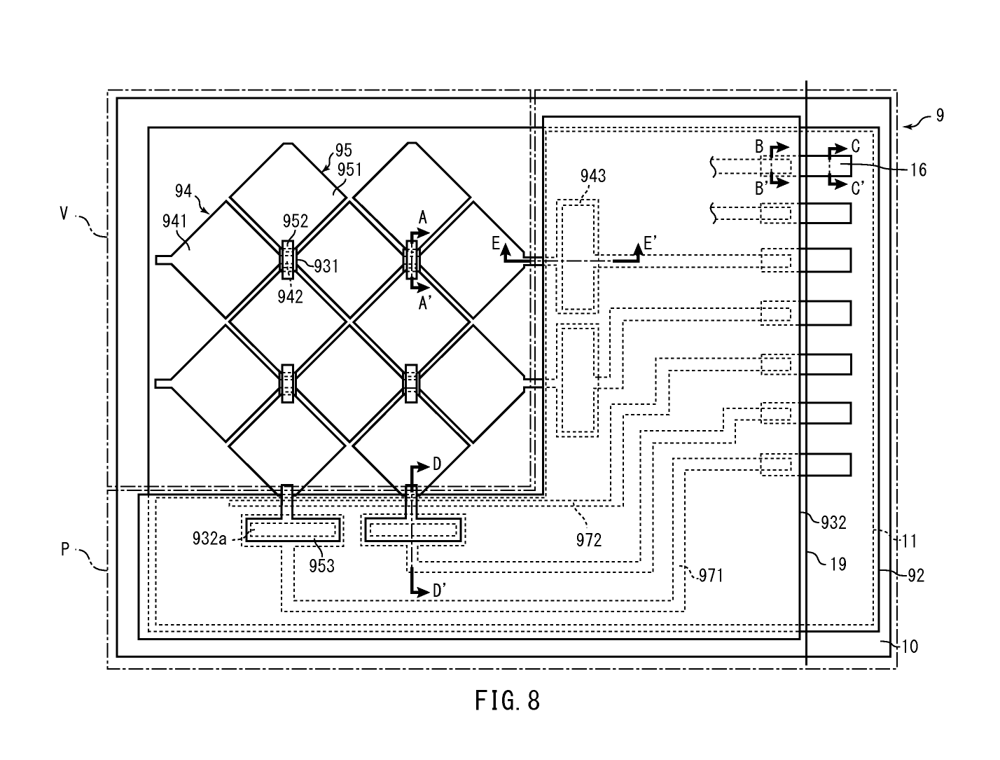

A method of manufacturing a touch panel 1 will be described below with reference to FIGS. 7A to 7E. FIGS. 7A to 7E show cross-sections taken along lines A-A′, B-B′, C-C′, D-D′ and E-E′ of FIG. 3.

First, as shown in FIG. 7A, a transparent conductive film is patterned to form insular electrodes 141 and connecting portions 142 for X electrodes 14, insular electrodes 151 for Y electrodes 15, terminals 16, and relay electrodes 18. First, a uniform transparent conductive film is formed by sputtering or chemical vapor deposition (CVD). The transparent conductive film may be made of ITO or IZO, for example. The transparent conductive film that has been formed is patterned photolithographically, for example. More specifically, a mask made of photoresist is formed in the regions where insular electrodes 141 and 151, connecting portions 142, terminals 16 and relay electrodes 18 are to be formed. Then, the uncovered portions are etched away. The etching may be performed using a mixture of phosphoric acid, acetic acid and nitric acid, or oxalic acid, for example. Once the patterning is completed, annealing is performed in the temperature range of 200 to 250° C. This annealing renders the amorphous transparent conductive film polycrystalline.

Next, as shown in FIG. 7B, a light-shielding film is patterned to form a light-shielding portion 11. The light-shielding film may be, for example, an acrylic resin or novolak resin with a pigment dispersed therein. The patterning may be performed by, for example, a printing method such as screen printing or flexography, an ink-jet technique or photolithography. By patterning the light-shielding film, the light-shielding portion 11 is formed in a predetermined position and contact holes 11a, 11b and 11c (see FIG. 3) are formed.

Next, as shown in FIG. 7C, an insulating film is patterned to form interlayer insulating films 121 and a planarizing film 122. The insulating film may be made of an organic insulating material mostly composed of an acrylic resin, novolak resin, epoxy resin, alkyl resin, phenol resin or silicon resin, for example. The patterning may be performed by, for example, a printing method such as screen printing or flexography, an ink-jet technique or photolithography. By patterning the insulating film, interlayer insulating films 121 and a planarizing film 122 are formed in predetermined positions and contact holes 122a, 122b and 122c (see FIG. 3) are formed.

The insulating film may also be a laminate including an inorganic insulating material (SiN, SiO or the like) and one of the above organic insulating materials. In this case, first, a film of inorganic insulating material is formed by CVD, for example. Next, an organic insulating material on the film of inorganic insulating material is patterned by the above patterning method. Then, the films of organic insulating material resulting from the patterning are used as a mask to dry-etch the film of inorganic insulating material. Thus, interlayer insulating films 121 and a planarizing film 122 are obtained that have been formed by depositing an inorganic insulating material and an organic insulating material in this order.

As discussed above, the planarizing film 122 preferably has a forward-tapered cross-section. Similarly, each interlayer insulating film 121 preferably has a forward-tapered cross-section. If the patterning is performed by photolithography, a forward-tapered geometry may be produced by exposing a film to light using a photomask in which the optical transmittance changes stepwise. If the patterning is performed by a printing method or an ink-jet technique, a forward-tapered geometry may be produced by, for example, regulating the recipe of the ink to adjust its viscosity, its wettability with respect to the underlying layer or its surface tension.

Next, as shown in FIG. 7D, a highly-conductive film is patterned to form lines 171 and connecting portions 152. Although not shown in FIG. 7D, a ground line 172 (see FIG. 3) is also formed in this step. The highly-conductive film has a lower electric resistance than at least the transparent conductive film. As discussed above, the highly-conductive film is preferably a laminate including a metal film and a light-shielding conductive film having a higher optical absorptance than the metal film. As discussed further below, the highly-conductive film may include still more layers deposited upon each other.

The light-shielding conductive film preferably has an optical absorptance of 96% or higher.

The light-shielding conductive film may be made of a black resin, for example. In this case, the light-shielding conductive film is patterned by a printing method such as screen printing or flexography, an ink-jet technique or photolithography, for example, to form light-shielding conductive films 171B for lines 171, a light-shielding conductive film for a ground line 172 and light-shielding conductive films 152B for connecting portions 152.

The light-shielding conductive film may also be an indium oxide film. The indium oxide film may be formed by sputtering, for example. In this case, it may be etched together with a metal film that is to be formed next, thereby reducing the number of steps.

Next, a metal film is formed. The metal film preferably has a low electric resistance, and may be made of Al, for example. However, when Al is in contact with a conductive oxide film such as ITO, differences in ionization tendency may produce galvanic corrosion. In view of this, the metal film is preferably a laminate with a metal having a high corrosion resistance. Thus, the metal film may suitably be a laminate film of MoNb, Al and MoNb, a laminate film of MoN, Al and MoN, or a laminate film of Mo, Al and Mo, for example.

The metal film, or the laminate film of the light-shielding conductive film and metal film, is photolithographically patterned. More specifically, a mask made of photoresist is formed in the regions where lines 171, a ground line 172 and connecting portions 152 are to be formed. Then, the uncovered portions are etched away. The etching may be performed using a mixture of phosphoric acid, acetic acid and nitric acid, for example. The use of this acid mixture allows the light-shielding conductive film and metal film to be etched together.

Thus, the lines 171, ground line 172 and connecting portions 152 are formed of the same material and in the same step.

Lastly, as shown in FIG. 7E, a protection film 19 is formed generally over the entire surface of the substrate 10. The protection film 19 may be an organic or inorganic material. The organic material may be an acrylic resin, for example, and may be formed using a spin coater or slit coater. The inorganic material may be SiN, for example, and may be formed by CVD. In any case, a mask or the like is used to form such a protection film 19 that will expose a portion of each of the terminals 16.

A construction of the touch panel 1 according to the first embodiment of the present invention and a method of manufacturing it have been described.

The touch panel 1 of the present embodiment includes a transparent conductive layer formed by patterning a transparent conductive film (i.e. the X electrodes 14 and the insular electrodes 151 of the Y electrodes 15, for example), a light-shielding layer formed by patterning a light-shielding film (i.e. the light-shielding portion 11), an insulating layer formed by patterning an insulating film (i.e. the interlayer insulating films 121 and planarizing film 122) and a highly-conductive layer formed by patterning a highly-conductive film (i.e. the lines 171 and the connecting portions 152 of the Y electrodes 15, for example), formed in this order.

In the method of manufacturing the touch panel 1 of the present embodiment, the planarizing film 122 and interlayer insulating films 121 are formed by a single round of patterning. This reduces the number of steps (and hence the number of masks) compared with implementations where they are patterned separately.

More specifically, the step of patterning a light-shielding film (FIG. 7B) and the step of patterning an insulating film (FIG. 7C) are performed between the step of patterning a transparent conductive film (FIG. 7A) and the step of patterning a highly-conductive film (FIG. 7D). Thus, for example, a connecting portion 142 of an X electrode 14 may cross a connecting portion 152 of a Y electrode 15 in a plan view, with an interlayer insulating film 121 sandwiched in between. Further, a relay electrode 18 may cross a line 171 in a plan view, with the light-shielding portion 11 and planarizing film 122 sandwiched in between. Here, the lines 171 and ground line 172 are formed on the planarizing film 122. As such, the lines 171 and ground line 172 are not broken by a step in the light-shielding portion 11. Moreover, even if the light-shielding portion 11 has a high surface roughness, the lines 171 and ground line 172 may be uniformly formed.

### Comparative Example 1

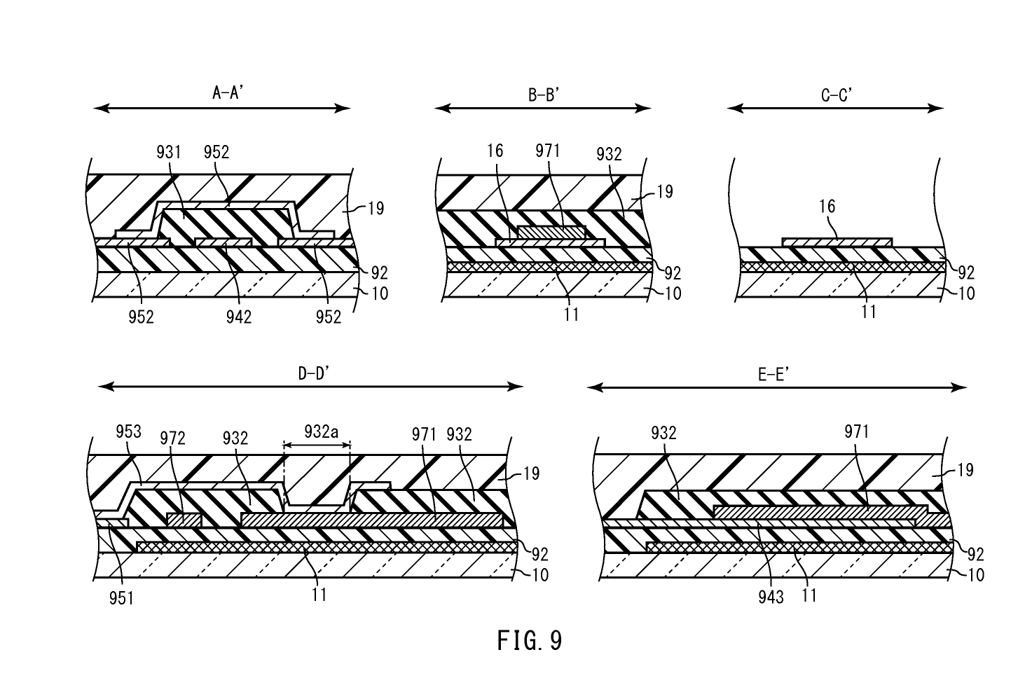

To illustrate the advantages of the touch panel 1 of the present embodiment, imaginary comparative examples will be described. FIG. 8 is a schematic plan view of a touch panel 9 according to a first comparative example. FIG. 9 shows cross-sections taken along lines A-A′, B-B′, C-C′, D-D′ and E-E′ of FIG. 8.

The touch panel 9 includes a substrate 10, a light-shielding portion 11, a planarizing film 92, interlayer insulating films 931 and 932, X electrodes 94, Y electrodes 95, terminals 16, lines 971, a ground line 972, relay electrodes 943 and 953 and a protection film 19.

To fabricate a touch panel 9, first, over the non-sensing area P of a substrate 10 is formed a light-shielding portion 11, and then a planarizing film 92 is formed over the entire substrate 10 including the light-shielding portion 11. X electrodes 94, Y electrodes 95 and other components are formed on the planarizing film 92.

The X electrodes 94 and Y electrodes 95 are all formed of transparent conductive films. That is, the insular electrodes 941 and connecting portions 942 of the X electrodes 94 and the insular electrodes 951 and connecting portions 952 of the Y electrodes 95 are formed of transparent conductive films. In addition, the terminals 16 and relay electrodes 943 and 953 are formed of transparent conductive films.

The lines 971 and ground line 972 are formed of metal films.

An X electrode 94 is electrically connected with a line 971 via a relay electrode 943. A Y electrode 95 is electrically connected with a line 971 via a relay electrode 953. A line 971 and the corresponding terminal 16 are in direct contact with each other. Similarly, the ground line 972 and the corresponding terminal 16 are in direct contact with each other.

The lines 971 and ground line 972, as well as portions of the terminals 16 are covered with an interlayer insulating film 932. A line 971 and a relay electrode 953 are in contact with each other via a contact hole 932a formed in the interlayer insulating film 932. This arrangement allows the relay electrodes 953 to cross the ground line 972 with the interlayer insulating film 932 sandwiched in between.

### Method of Manufacturing Touch Panel 91

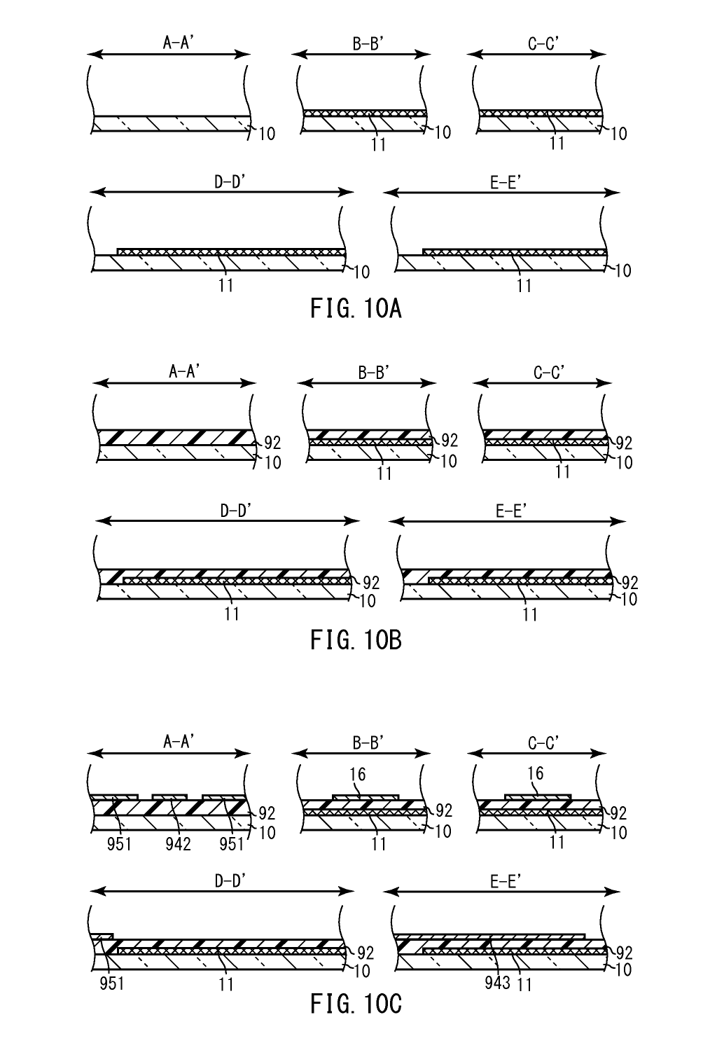

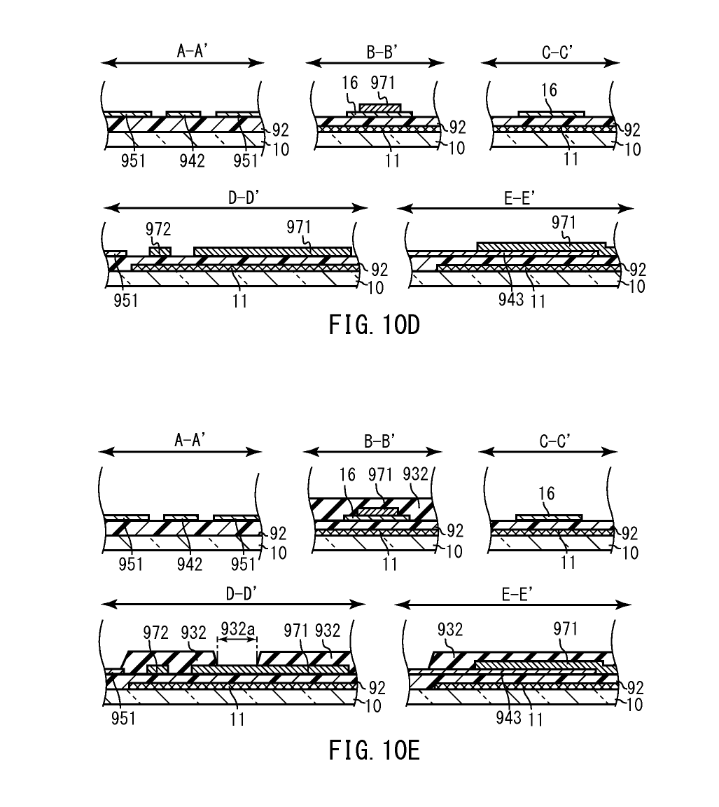

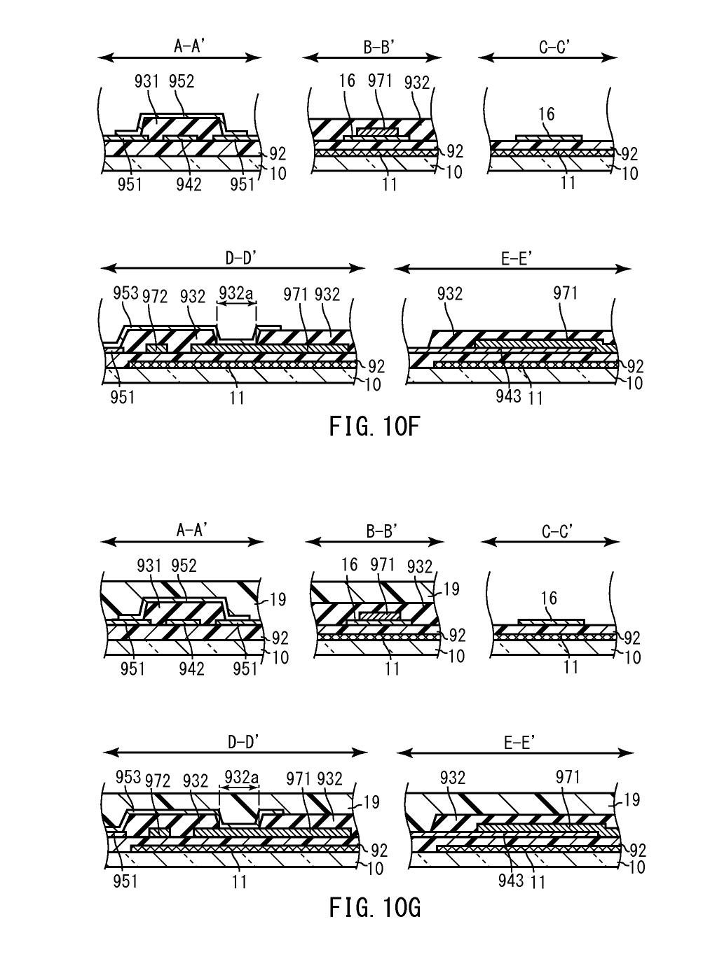

A method of manufacturing the touch panel 9 will be briefly described with reference to FIGS. 10A to 10G. FIGS. 10A to 10G show cross-sections taken along lines A-A′, B-B′, C-C′, D-D′ and E-E′ of FIG. 8.

First, as shown in FIG. 10A, a light-shielding film is patterned to form a light-shielding portion 11.

Next, as shown in FIG. 10B, a planarizing film 92 is formed. Similar to the planarizing film 122, the planarizing film 92 may be mostly composed of an acrylic resin, novolak resin, epoxy resin, alkyl resin, phenol resin or silicon resin. A film of one of these materials is formed using a spin coater or slit coater, for example, to form a planarizing film 92.

Next, as shown in FIG. 10C, a transparent conductive film is patterned to form connecting portions 942 for X electrodes 94, insular electrodes 951 for Y electrodes 95, relay electrodes 943 and terminals 16. Although not shown in FIG. 10C, insular electrodes 941 for the X electrodes 94 are also formed in this step.

Next, as shown in FIG. 10D, a metal film is patterned to form lines 971 and a ground line 972.

Next, as shown in FIG. 10E, an insulating film is patterned to form interlayer insulating films 931 and 932. Contact holes 932a are formed at the same time.

Next, as shown in FIG. 10F, a transparent conductive film different from that of FIG. 10C is patterned to form connecting portions 952 for the Y electrodes 95 and relay electrodes 953.

Lastly, as shown in FIG. 10G, a protection film 19 is formed.

As such, manufacturing the touch panel 9 requires seven steps: the step of patterning a light-shielding film (FIG. 10A), the step of forming a planarizing film 92 (FIG. 10B), the step of patterning a transparent conductive film (FIG. 10C), the step of patterning a metal film (FIG. 10D), the step of patterning an insulating film (FIG. 10E), the step of patterning another transparent conductive film (FIG. 10F), and the step of forming a protection film 19 (FIG. 10G). Particularly, if the patterning is performed by photolithography, each of these steps requires film formation, resist application, exposition to light, etching, resist removal and washing. Increased number of steps reduces productivity and yield, increasing the cost of production.

In contrast, the touch panel 1 of the first embodiment of the present invention may be manufactured by five steps: the step of patterning a transparent conductive film (FIG. 7A), the step of patterning a light-shielding film (FIG. 7B), the step of patterning an insulating film (FIG. 7C), the step of patterning a highly-conductive film (FIG. 7D), and the step of forming a protection film 19 (FIG. 7E). That is, the number of steps (and hence the number of masks) may be reduced compared with that for the touch panel 9.

### Comparative Example 2

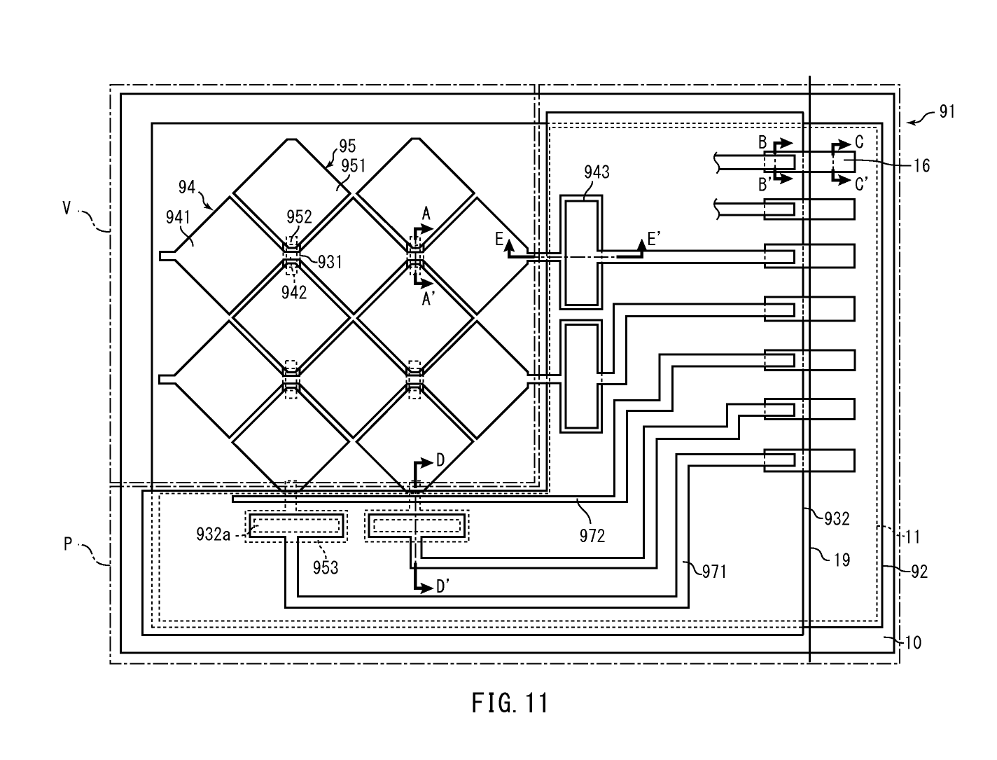

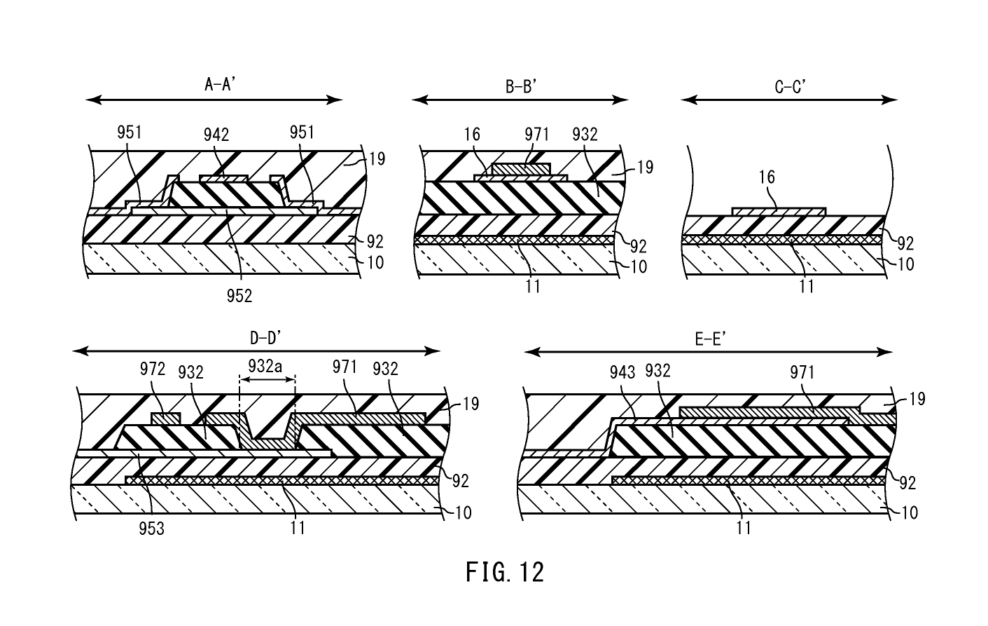

FIG. 11 is a schematic plan view of a touch panel 91 according to a second comparative example. FIG. 12 shows cross-sections taken along lines A-A′, B-B′, C-C′, D-D′ and E-E′ of FIG. 11.

The touch panel 91 is different from the touch panel 9 in terms of the order in which the components are formed. As such, the films are deposited in a different order.

### Method of Manufacturing Touch Panel 91

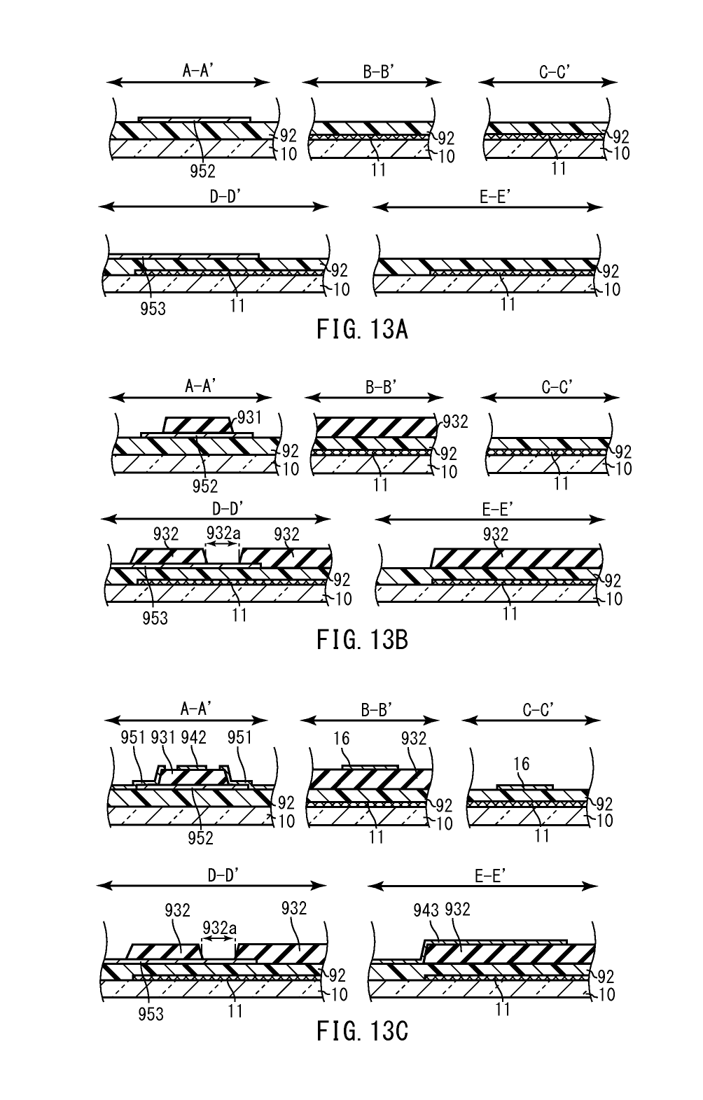

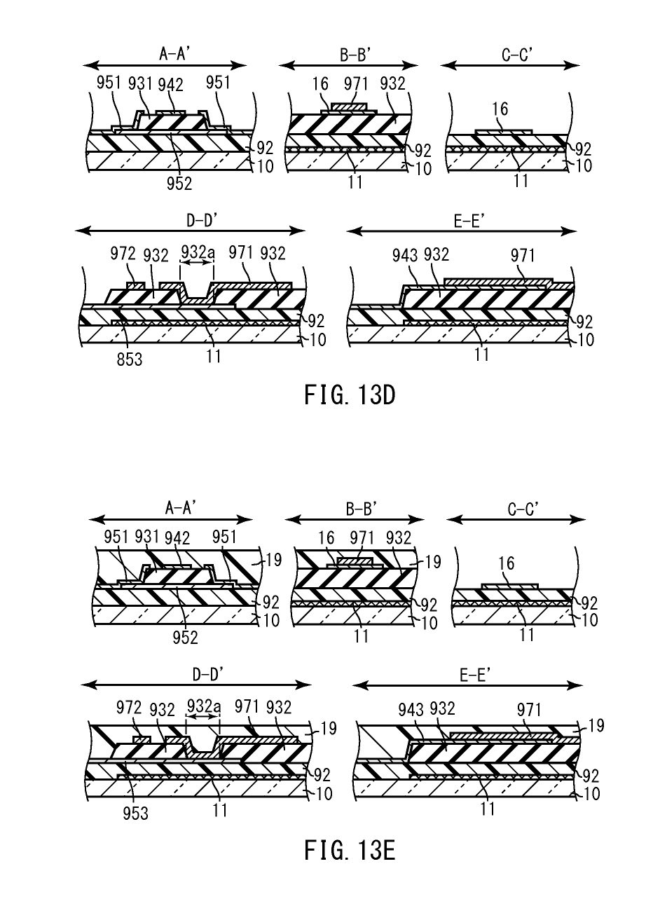

A method of manufacturing the touch panel 91 will be briefly described with reference to FIGS. 13A to 13E. FIGS. 13A to 13E show cross-sections taken along lines A-A′, B-B′, C-C′, D-D′ and E-E′ of FIG. 11.

First, on a substrate 10 are formed a light-shielding portion 11 and a planarizing film 92. These steps are the same as those for the touch panel 9, and thus they are not illustrated in drawings (see FIGS. 10A and 10B).

Next, as shown in FIG. 13A, a transparent conductive film is patterned to form connecting portions 952 for Y electrodes 95 and relay electrodes 953.

Next, as shown in FIG. 13B, an insulating film is patterned to form an interlayer insulating films 931 and 932. Contact holes 932a are formed at the same time.

Next, as shown in FIG. 13C, a transparent conductive film different from that of FIG. 13A is patterned to form connecting portions 942 for X electrodes 94, insular electrodes 951 for the Y electrodes 95, relay electrodes 943 and terminals 16. Although not shown in FIG. 13C, insular electrodes 941 for the X electrodes 94 are also formed in this step.

Next, as shown in FIG. 13D, a metal film is patterned to form lines 971 and a ground line 972.

Lastly, as shown in FIG. 13E, a protection film 19 is formed.

Thus, similar to the manufacturing of the touch panel 9, manufacturing the touch panel 91 requires seven steps: the step of patterning a light-shielding film, the step of forming a planarizing film 92, the step of patterning a transparent conductive film (FIG. 13A), the step of patterning an insulating film (FIG. 13B), the step of patterning another transparent conductive film (FIG. 13C), the step of patterning a metal film (FIG. 13D), and the step of forming a protection film 19 (FIG. 13F). The method of manufacturing the touch panel 1 according to the first embodiment of the present invention reduces the number of steps.

### Second Embodiment

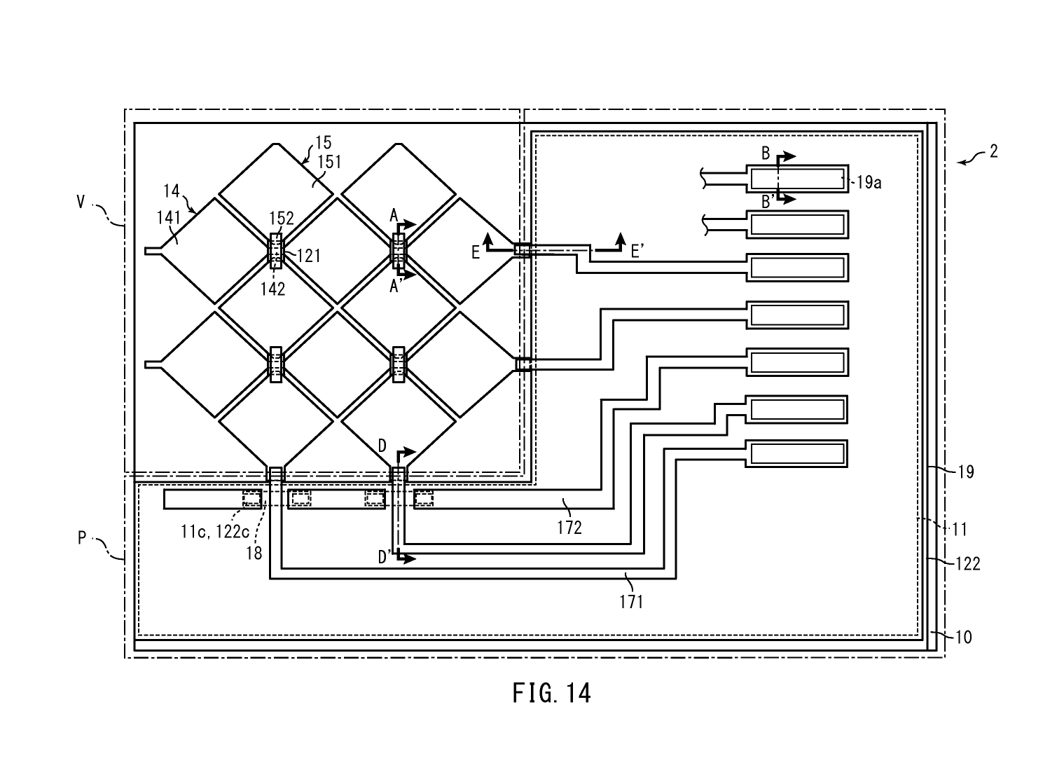

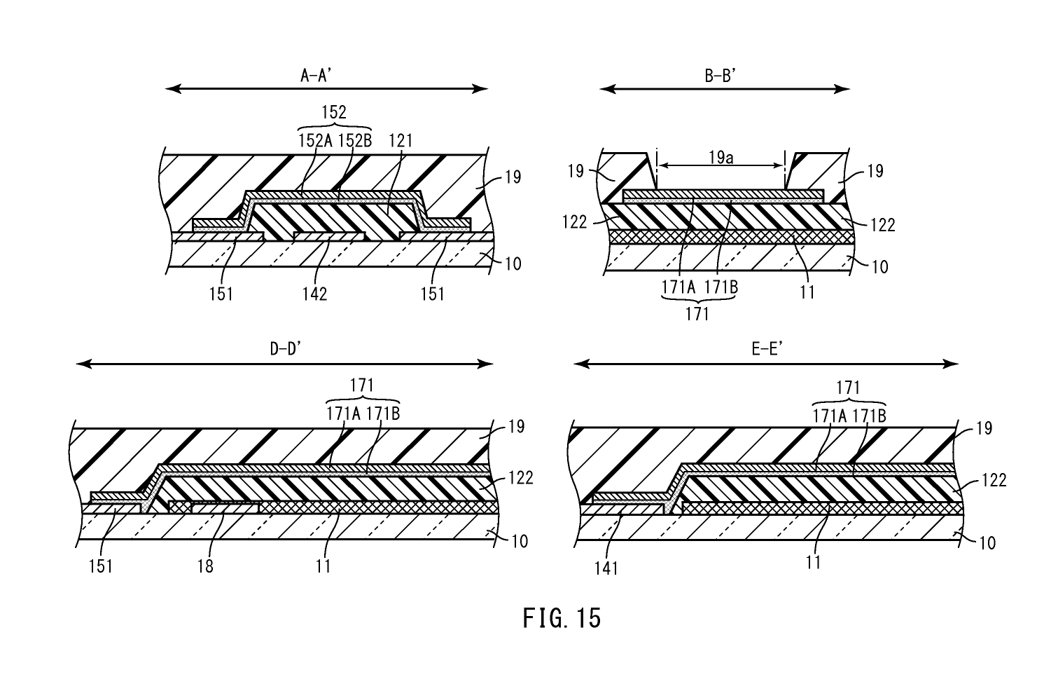

The touch panel-equipped display device 100 or 200 may include any one of touch panels 2 to 8, described below, instead of the touch panel 1. FIG. 14 is a schematic plan view of a touch panel 2 according to a second embodiment of the present invention. FIG. 15 shows cross-sections taken along lines A-A′, B-B′, D-D′ and E-E′ of FIG. 14.

The touch panel 2 is different from the touch panel 1 in terms of the construction of the terminals.

In the touch panel 1, the terminals 16 are formed of transparent conductive films. In contrast, in the touch panel 2, an end of each of the lines 171 and ground line 172 forms a terminal. That is, in the touch panel 2, each of the lines 171 and ground line 172 is exposed through a contact hole 19a formed in the protection film 19. Then, the line 171 or ground lie 172 is connected with an external drive circuit or the like via the contact hole 19a.

In the touch panel 2, the protection film 19 is preferably made of an inorganic film to prevent corrosion of the lines 171 and ground line 172.

Compared with the arrangement of the touch panel 1, i.e. compared with implementations where the terminals 16 are formed of transparent conductive films, the arrangement of the touch panel 2 reduces the contact resistance of the terminals.

On the other hand, in the touch panel 1, the exposed portions (i.e. the terminals 16) are formed of transparent conductive films, which have a high corrosion resistance. As such, the thickness of the protection film 19 may be made smaller than that for the touch panel 2.

### Third Embodiment

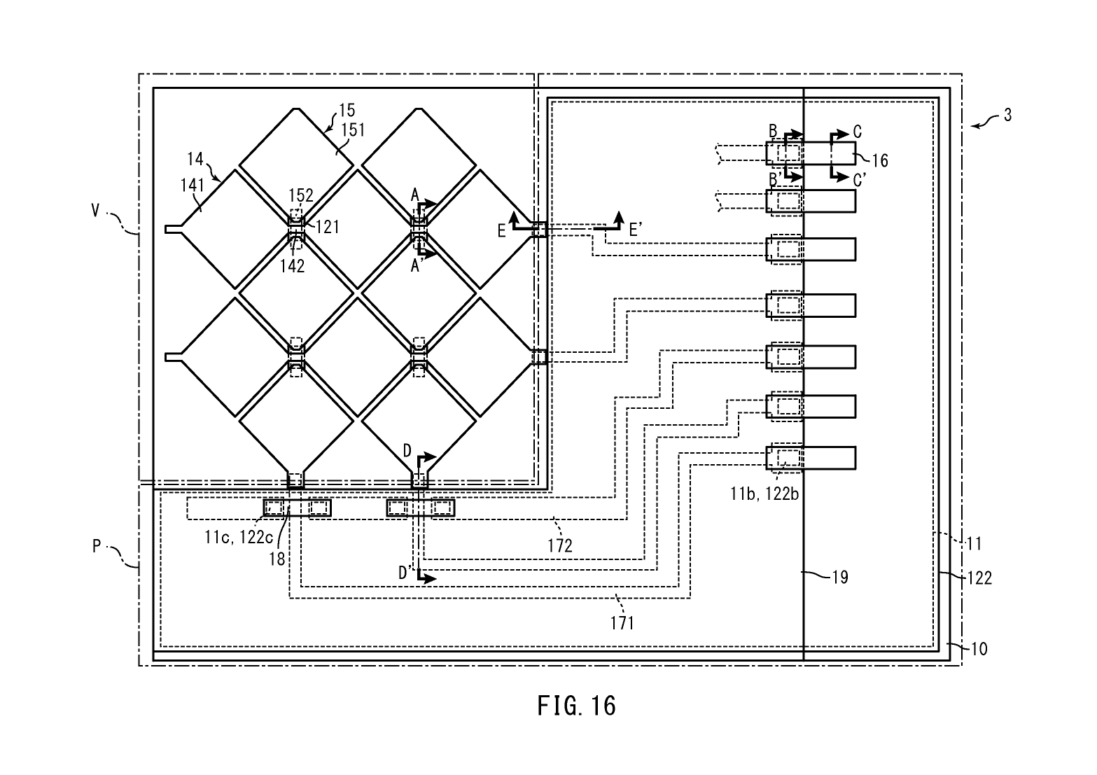

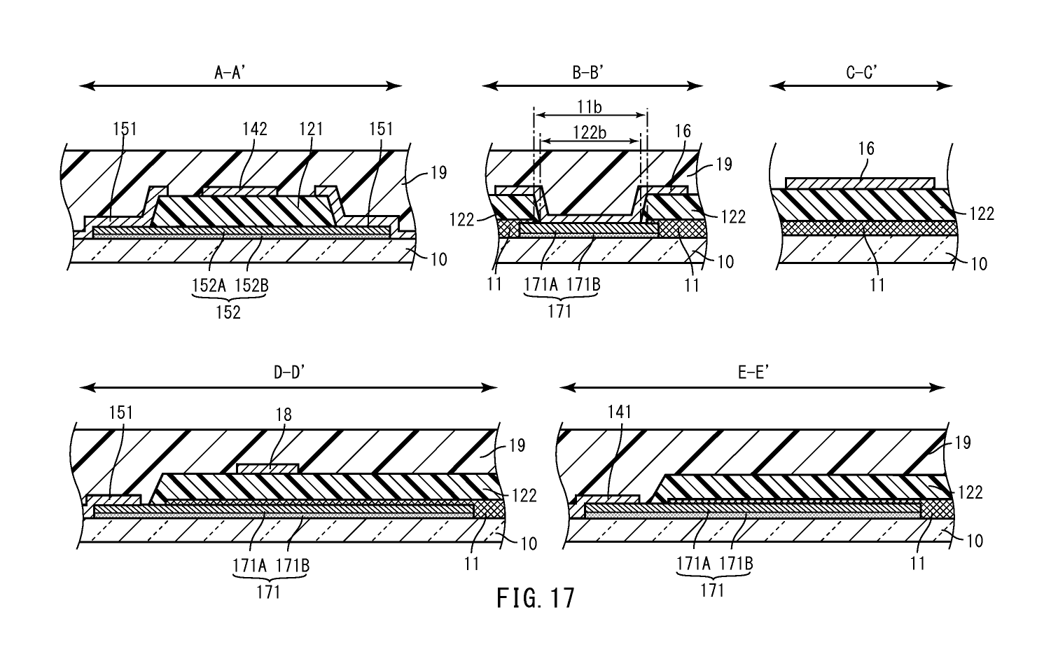

FIG. 16 is a schematic plan view of a touch panel 3 according to a third embodiment of the present invention. FIG. 17 shows cross-sections taken along lines A-A′, B-B′, C-C′, D-D′ and E-E′ of FIG. 16.

The touch panel 3 is different from the touch panel 1 in terms of the order in which the components are formed. As such, the films are deposited in a different order. In the present embodiment, the terminals 16 are located on the planarizing film 122. As such, the contact holes 122a formed in the planarizing film 122 of the touch panel 1 (see FIG. 3) are not necessary in the touch panel 3.

### Method of Manufacturing Touch Panel 3

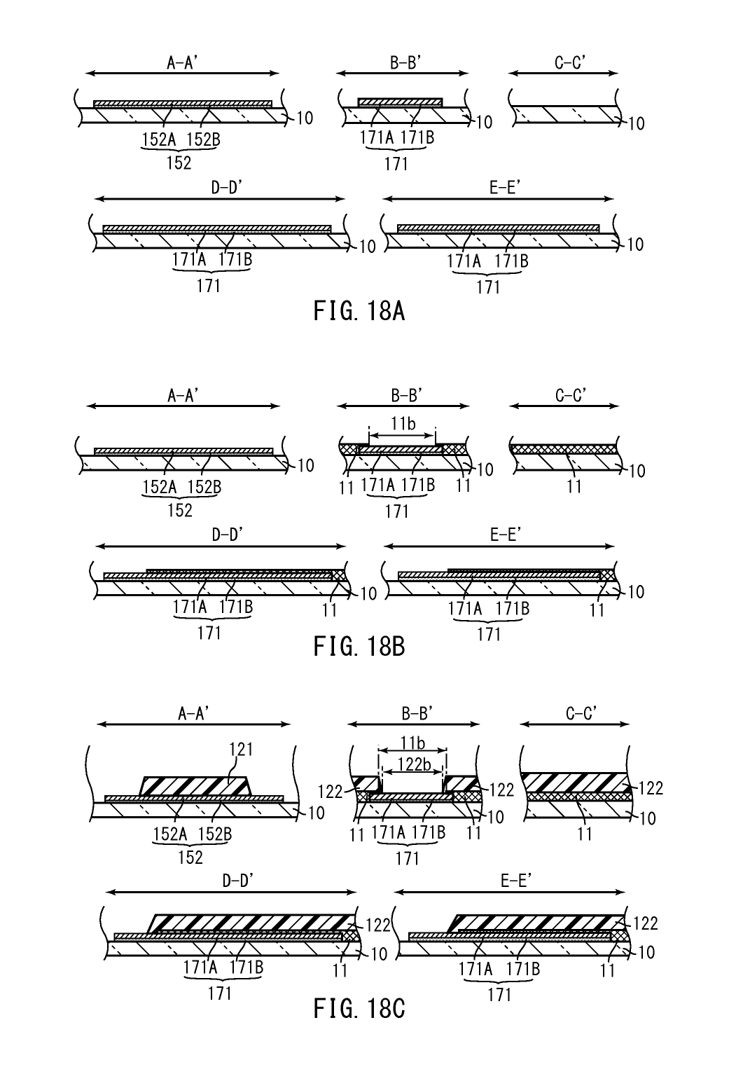

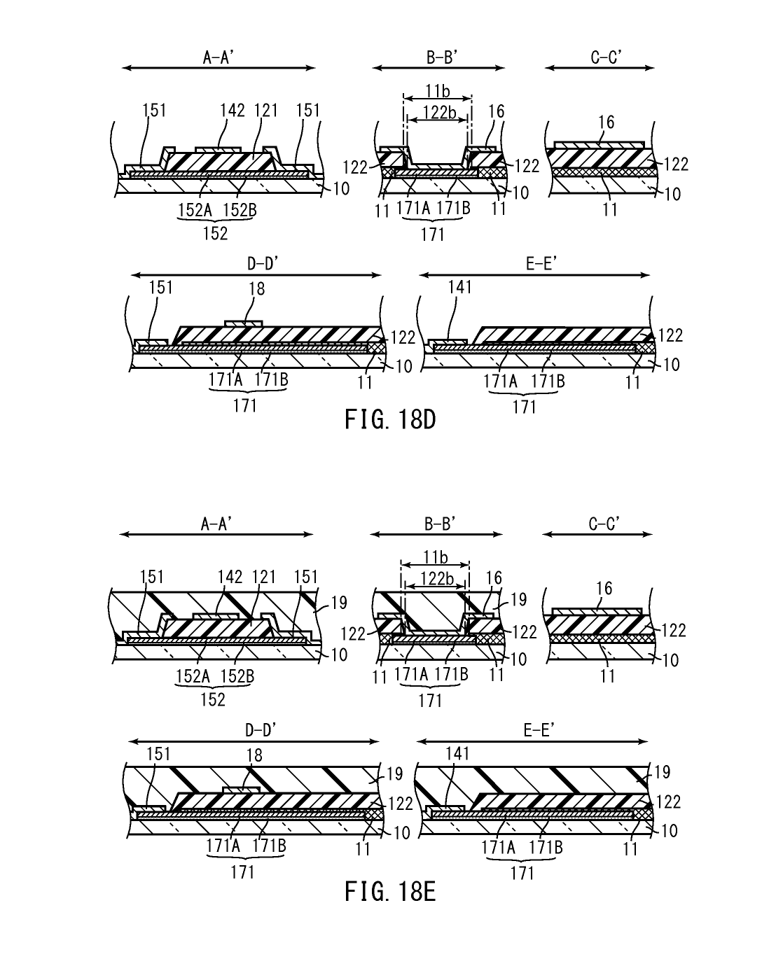

A method of manufacturing the touch panel 3 will be briefly described with reference to FIGS. 18A to 18E. FIGS. 18A to 18E show cross-sections taken along lines A-A′, B-B′, C-C′, D-D′ and E-E′ of FIG. 16.

First, as shown in FIG. 18A, a highly-conductive film is patterned to form lines 171 and connecting portions 152. Although not shown in FIG. 18A, a ground line 172 (see FIG. 16) is also formed in this step. In the present embodiment, too, the highly-conductive film is preferably a laminate including a metal film and a light-shielding conductive film.

Next, as shown in FIG. 18B, a light-shielding film is patterned to form a light-shielding portion 11.

Next, as shown in FIG. 18C, an insulating film is patterned to form interlayer insulating films 121 and a planarizing film 122. In the present embodiment, the planarizing film 122 also serves to protect the lines 171 and ground line 172. Accordingly, the insulating film is preferably thick. The insulating film is preferably a laminate including an inorganic insulating material and an organic insulating material.

Next, as shown in FIG. 18D, a transparent conductive film is patterned to form insular electrodes 141 and connecting portions 142 for X electrodes 14, insular electrodes 151 for Y electrodes 15, terminals 16, and relay electrodes 18.

Lastly, as shown in FIG. 18E, a protection film 19 is formed.

A construction of the touch panel 3 according to the third embodiment of the present invention and a method of manufacturing it have been described.

The touch panel 3 of the present embodiment includes a highly-conductive layer formed by patterning a highly-conductive film (i.e. the lines 171 and the connecting portions 152 of the Y electrodes 15, for example), a light-shielding layer formed by patterning a light-shielding film (i.e. the light-shielding portion 11), an insulating layer formed by patterning an insulating film (i.e. the interlayer insulating films 121 and planarizing film 122) and a transparent conductive layer formed by patterning a transparent conductive film (i.e. the X electrodes 14 and the insular electrodes 151 of the Y electrodes 15, for example), formed in this order.

The arrangement of the touch panel 3 also reduces the number of steps compared with the arrangements of the touch panels 9 and 91.

### Fourth Embodiment

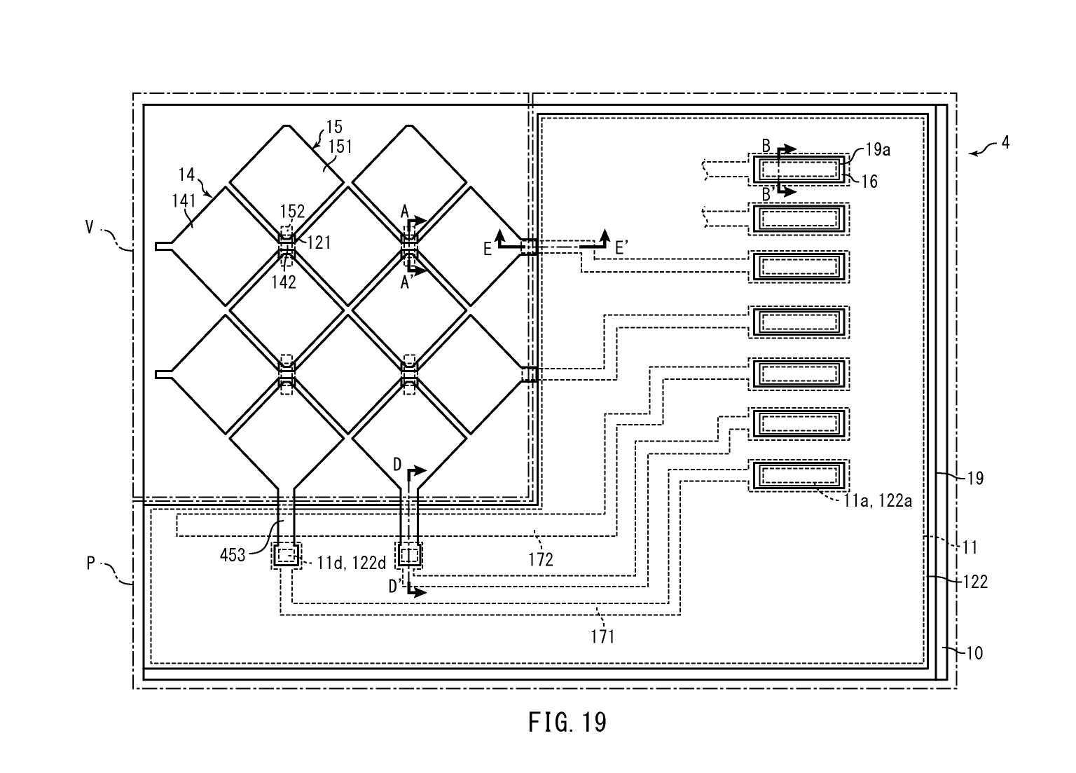

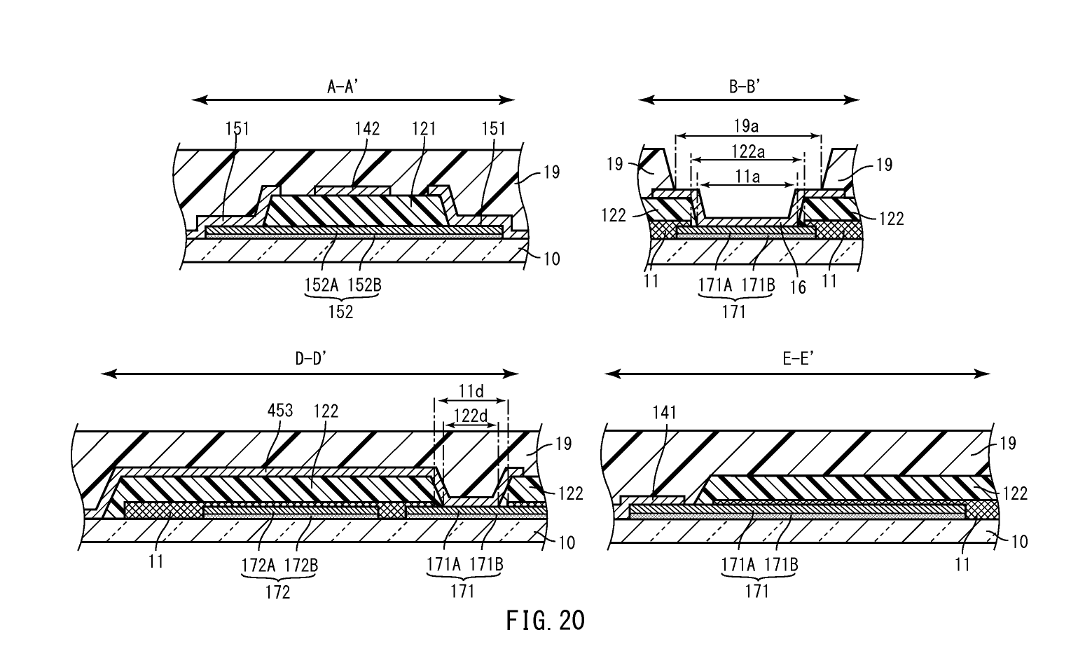

FIG. 19 is a schematic plan view of a touch panel 4 according to a fourth embodiment of the present invention. FIG. 20 shows cross-sections taken along lines A-A′, B-B′, D-D′ and E⁻E′ of FIG. 19. In FIG. 20, 172A denotes a metal film that forms a portion of the ground line 172, while 172B denotes a light-shielding conductive film that forms a portion of the ground line 172.

The touch panel 4 is different from the touch panel 3 in terms of the construction of the terminals.

Each terminal of the touch panel 4 includes a line 171 or ground line 172 and a terminal 16 formed of a transparent conductive film, deposited in this order. Then, substantially the entire terminals 16 are covered with the protection film 19. In the touch panel 4, a portion of a terminal 16 is exposed via a contact hole 11a formed in the light-shielding portion 11 and a contact hole 122a formed in the planarizing film 122, and, in addition, a contact hole 19a formed in the protection film 19. Then, the terminal 16 is connected with an external drive circuit or the like via the contact holes 11a, 122a and 19a.

In the touch panel 4, the terminals have a lower resistance than those in the touch panel 3.

The touch panel 4 is further different from the touch panel 3 in terms of the construction of the connections between the lines 171 and the Y electrodes 15.

The touch panel 4 further includes relay electrodes 453 each formed integrally with one insular electrode 151 of a Y electrode 15. The relay electrodes 453 are formed of the same material in the same step as the insular electrodes 141 and connecting portions 142 of the X electrodes 14, the insular electrodes 151 of the Y electrodes 15 and the terminals 16. A relay electrode 453 is in contact with a line 171 via a contact hole 11d formed in the light-shielding portion 11 and a contact hole 122d formed in the planarizing film 122.

In the touch panel 4, as opposed to the touch panel 3, there is no bridge for the ground line 172. That is, the ground line 172 is not relayed via relay electrodes 18 as in the touch panel 3 (FIG. 16). This reduces the resistance of the ground line 172.

On the other hand, in the touch panel 3, a Y electrode 15 and the corresponding line 171 are in direct contact with each other. That is, there is no need for a contact hole in between as in the touch panel 4. This reduces the resistance of the line 171.

### Fifth Embodiment

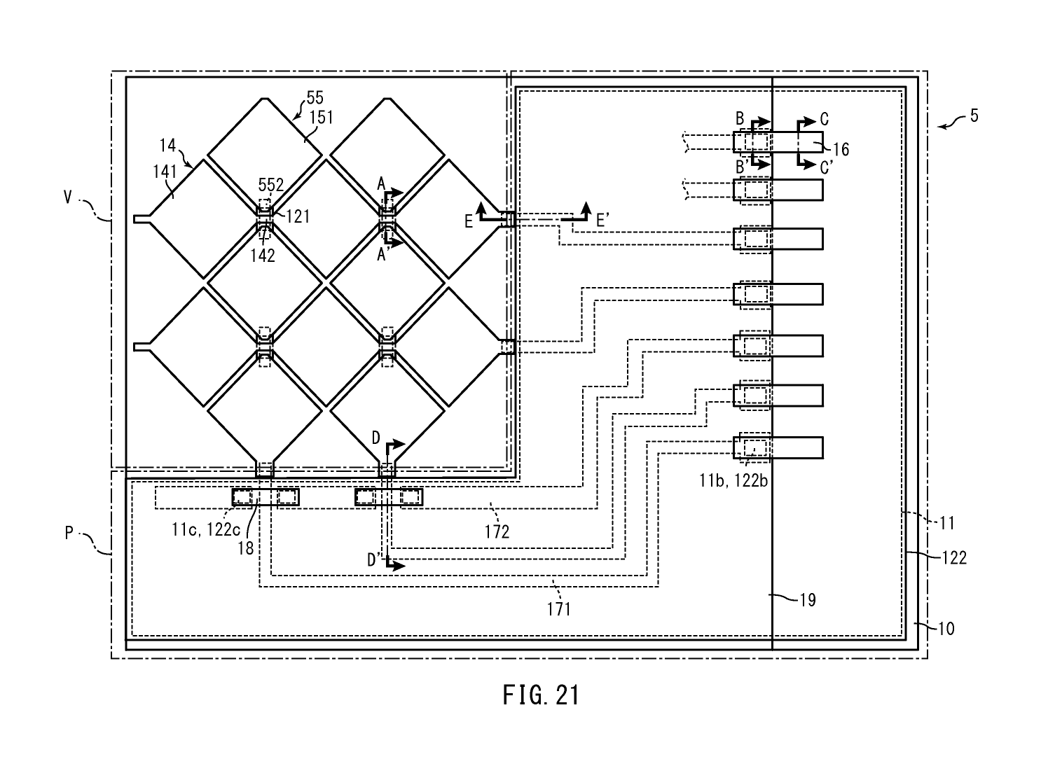

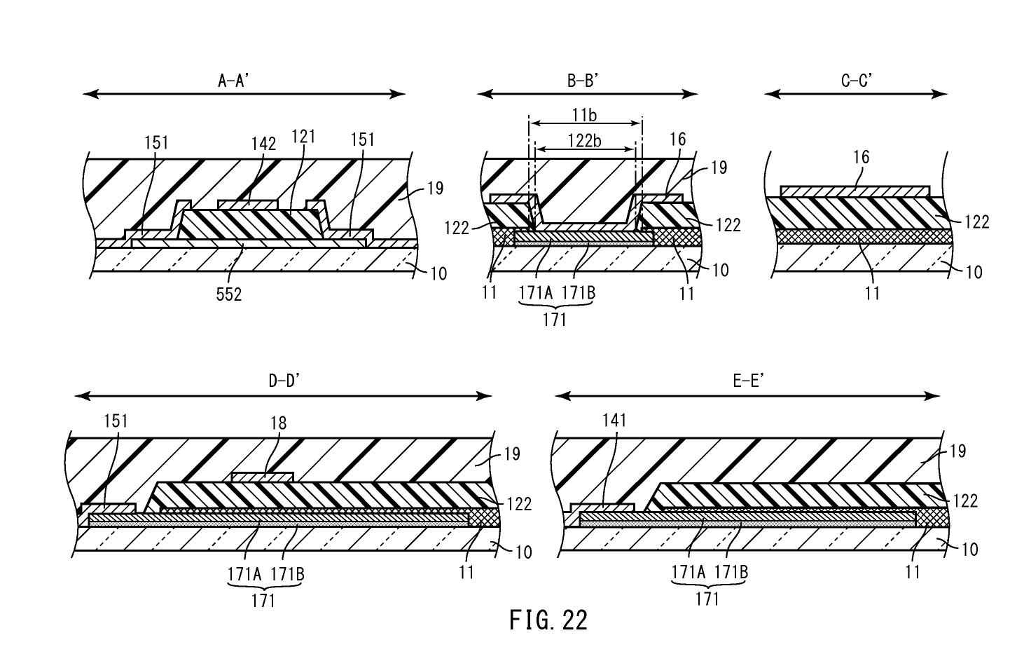

FIG. 21 is a schematic plan view of a touch panel 5 according to a fifth embodiment of the present invention. FIG. 22 shows cross-sections taken along lines A-A′, B-B′, C-C′, D-D′ and E-E′ of FIG. 21.

In the touch panel 5, the Y electrodes 15 of the touch panel 3 (see FIG. 16) are replaced by Y electrodes 55. AY electrode 55 includes insular electrodes 151 and connecting portions 552. The connecting portions 152 of the Y electrodes 15 of the touch panel 3 are formed of the same material in the same step as the lines 171 and ground line 172. In contrast, the connecting portions 552 of the Y electrodes 55 of the touch panel 5 are formed of transparent conductive films.

### Method of Manufacturing Touch Panel 5

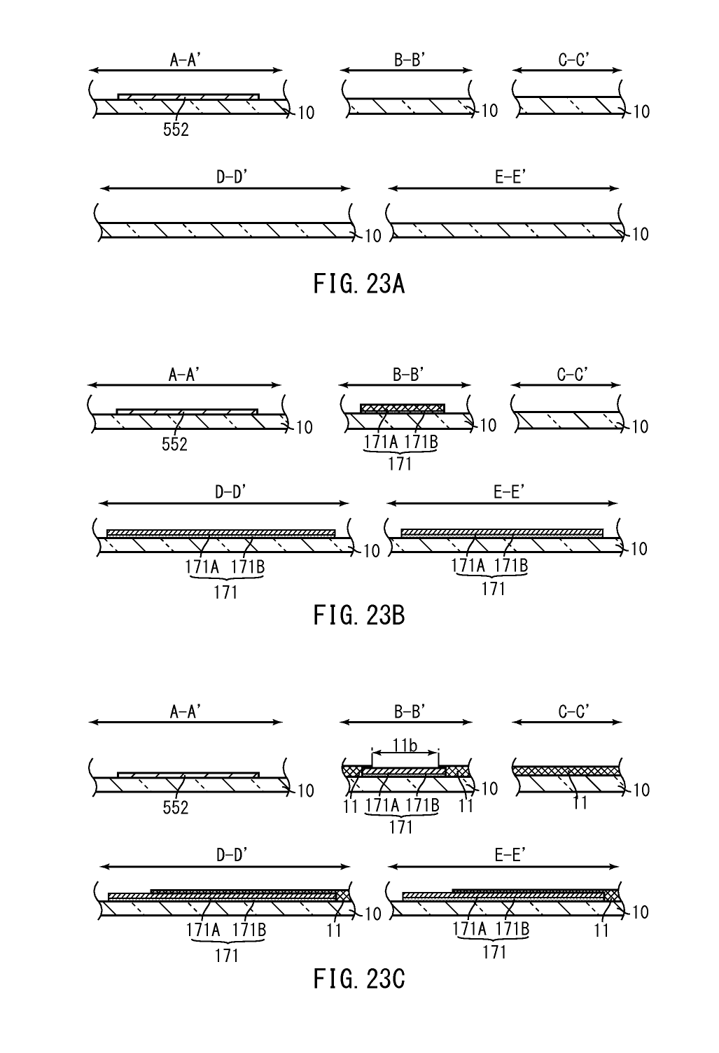

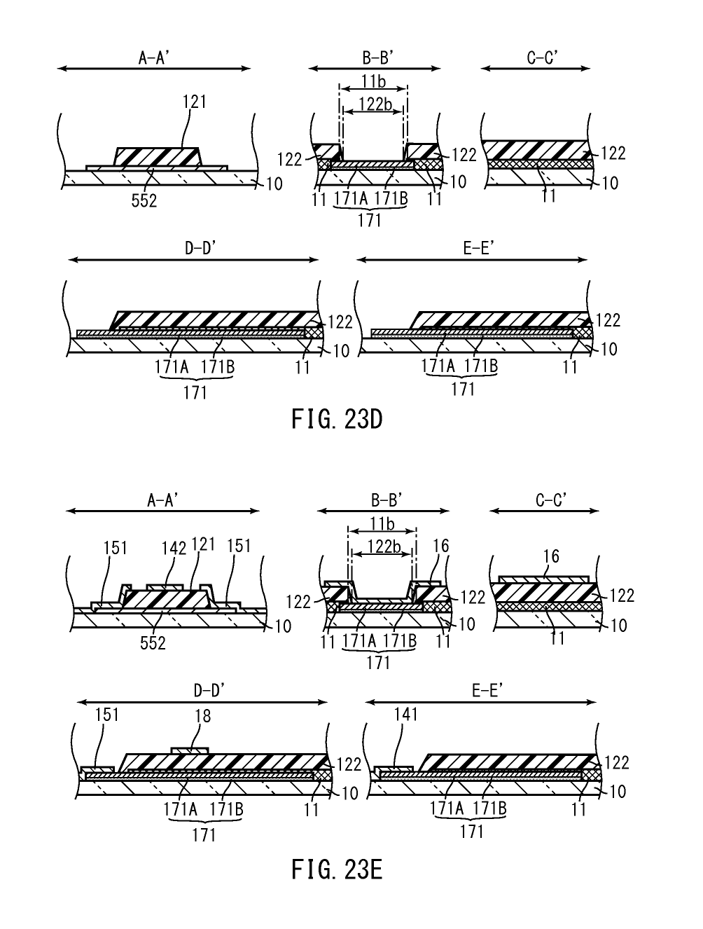

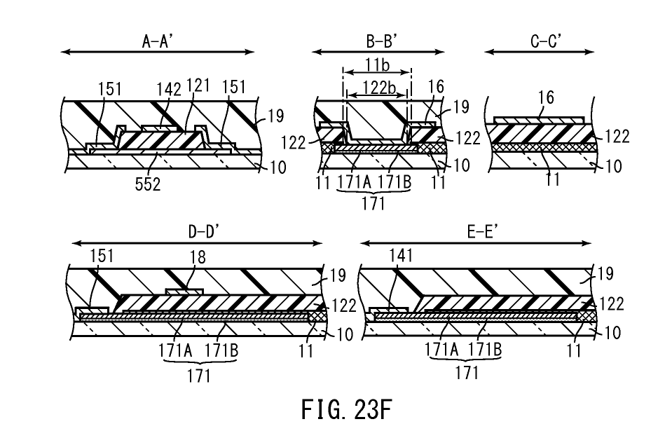

A method of manufacturing the touch panel 5 will be briefly described with reference to FIGS. 23A to 23F. FIGS. 23A to 23F show cross-sections taken along lines A-A′, B-B′, C-C′, D-D′ and E-E′ of FIG. 21.

First, as shown in FIG. 23A, a transparent conductive film is patterned to form connecting portions 552. The transparent conductive film may be made of ITO or IZO, for example. The transparent conductive film is formed by CVD or sputtering, for example, and is photolithographically patterned.

Next, as shown in FIG. 23B, a highly-conductive film is patterned to form lines 171. Although not shown in FIG. 23B, a ground line 172 (see FIG. 21) is also formed in this step. In the present embodiment, too, the highly-conductive film is preferably a laminate including a metal film and a light-shielding conductive film.

Next, as shown in FIG. 23C, a light-shielding film is patterned to form a light-shielding portion 11.

Next, as shown in FIG. 23D, an insulating film is patterned to form interlayer insulating films 121 and a planarizing film 122. In the present embodiment, too, the planarizing film 122 serves to protect the lines 171 and ground line 172. Accordingly, the insulating film is preferably thick. Further, the insulating film is preferably a laminate including an inorganic insulating material and an organic insulating material.

Next, as shown in FIG. 23E, a transparent conductive film different from that of FIG. 23A is patterned to form insular electrodes 141 and connecting portions 142 for X electrodes 14, insular electrodes 151 for the Y electrodes 55, terminals 16 and relay electrodes 18. To distinguish between the transparent conductive film of FIG. 23A and the transparent conductive film of FIG. 23E, the transparent conductive film of FIG. 23E will be referred to as first transparent conductive film, while the transparent conductive film of FIG. 23A will be referred to as second transparent conductive film. The first and second transparent conductive films may be made of ITO or IZO, for example. The first and second transparent conductive films may be made of the same material or different materials. The first and second transparent conductive films may be formed by the same method or different methods, and may be patterned by the same method or different methods.

Lastly, as shown in FIG. 23F, a protection film 19 is formed.

A construction of the touch panel 5 according to the fifth embodiment of the present invention and a method of manufacturing it have been described.

The touch panel 5 of the present embodiment includes a second transparent conductive layer formed by patterning a second transparent conductive film (i.e. the connecting portions 552 of the Y electrodes 55), a highly-conductive layer formed by patterning a highly-conductive film (i.e. the lines 171, for example), a light-shielding layer formed by patterning a light-shielding film (i.e. the light-shielding portion 11), an insulating layer formed by patterning an insulating film (i.e. the interlayer insulating films 121 and planarizing film 122), and a first transparent conductive layer formed by patterning a first transparent conductive film (i.e. the X electrodes 14 and the insular electrodes 151 of the Y electrodes 55, for example), formed in this order.

In the touch panel 5 of the present embodiment, the connecting portions 552 of the Y electrodes 55 are formed from the second transparent conductive film. As such, the connecting portions 552 may be less visible than the connecting portions 152 of the Y electrodes 15 formed from a highly-conductive film, as in the touch panels 1 to 4.

The touch panel 5 of the present embodiment may be manufactured by six steps: the step of patterning a second transparent conductive film (FIG. 23A), the step of patterning a highly-conductive film (FIG. 23B), the step of patterning a light-shielding film (FIG. 23C), the step of patterning an insulating film (FIG. 23D), the step of patterning a first transparent conductive film (FIG. 23E), and the step of forming a protection film 19 (FIG. 23F). This reduces the number of steps compared with the arrangements of the touch panels 9 and 91.

### Sixth Embodiment

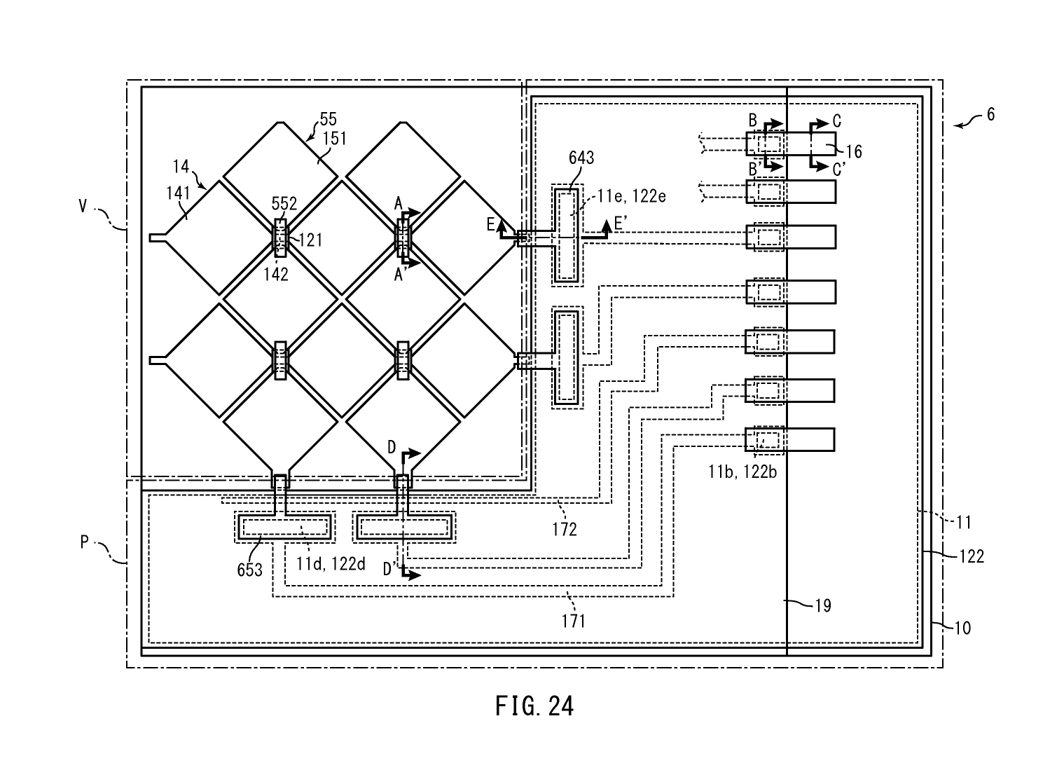

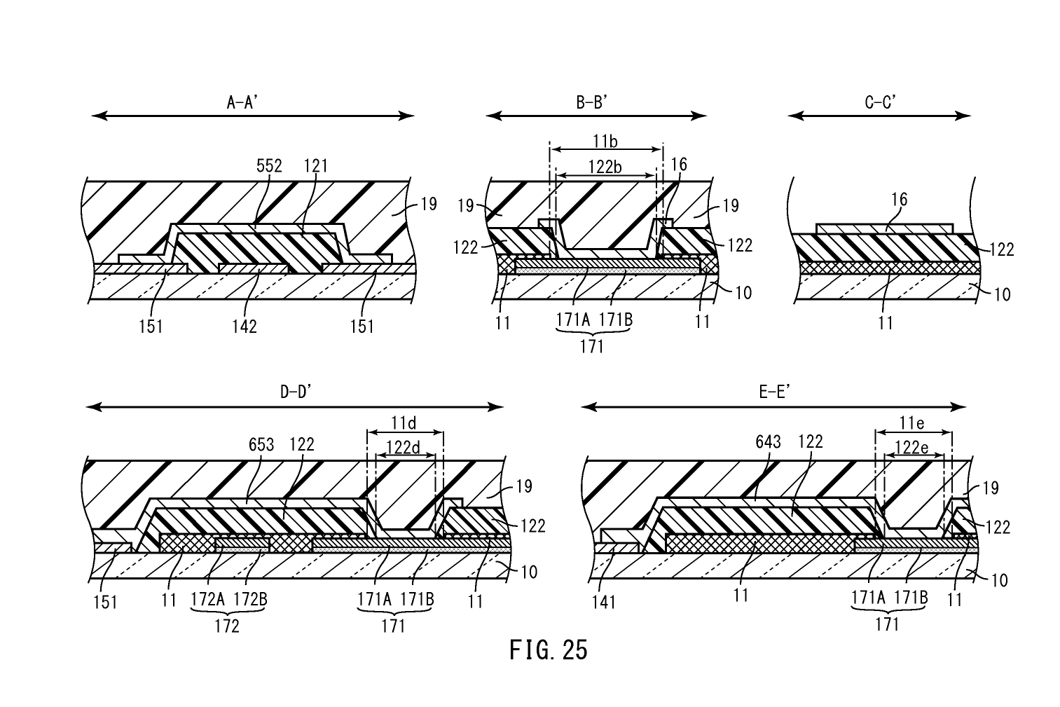

FIG. 24 is a schematic plan view of a touch panel 6 according to a sixth embodiment of the present invention. FIG. 25 shows cross-sections taken along lines A-A′, B-B′, C-C′, D-D′ and E-E′ of FIG. 24.

The touch panel 6 is different from the touch panel 5 (FIG. 21) in terms of the order in which the components are formed. As such, the films are deposited in a different order.

In addition, the touch panel 6 is different from the touch panel 5 in terms of the construction of the connections between the X electrodes 14 and lines 171 and the construction of the connections between the Y electrodes 55 and lines 171. The touch panel 6 includes relay electrodes 643 and 653 instead of the relay electrodes 18 of the touch panel 5.

In the touch panel 6, an X electrode 14 is connected with a line 171 via a relay electrode 643. The relay electrodes 643 are formed of the same material in the same step as the connecting portions 552 of the Y electrodes 55. One insular electrode 141 of an X electrode 14 is in direct contact with a relay electrode 643. The relay electrode 643 is in contact with a line 171 via a contact hole 11e formed in the light-shielding portion 11 and a contact hole 122e formed in the planarizing film 122.

Similarly, a Y electrode 55 is connected with a line 171 via a relay electrode 653. The relay electrodes 653 are formed of the same material in the same step as the connecting portions 552 of the Y electrodes 55. One insular electrode 151 of a Y electrode 55 is in direct contact with a relay electrode 653. The relay electrode 653 is in contact with a line 171 via a contact hole 11d formed in the light-shielding portion 11 and a contact hole 122d formed in the planarizing film 122.

### Method of Manufacturing Touch Panel 6

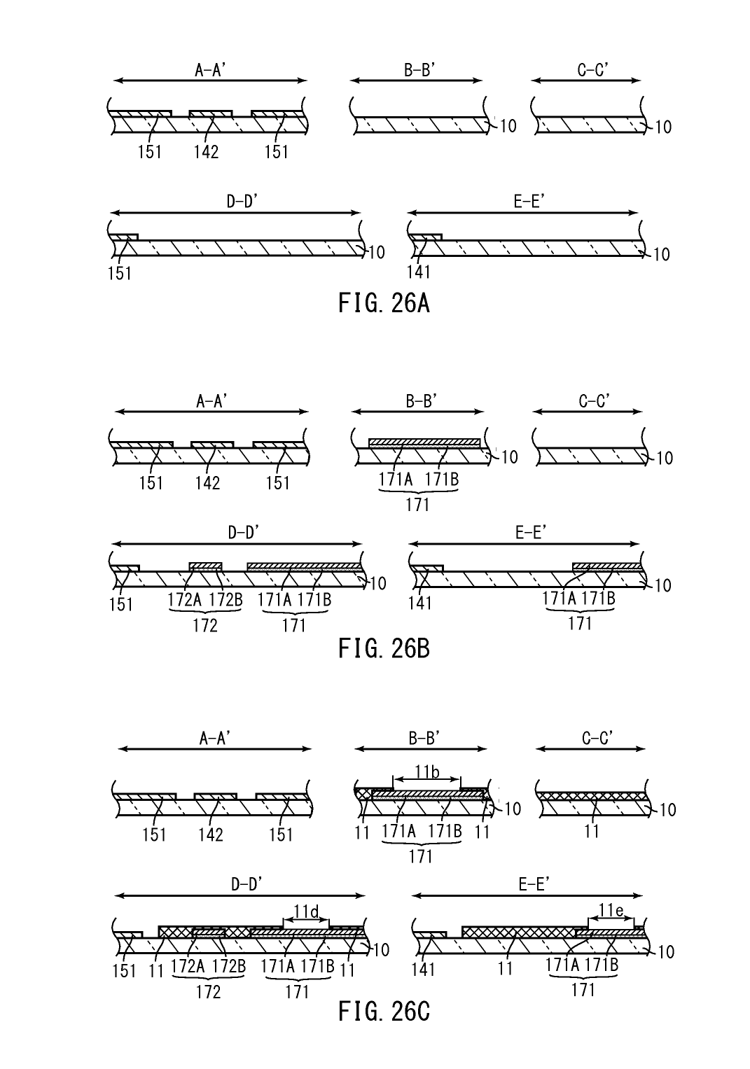

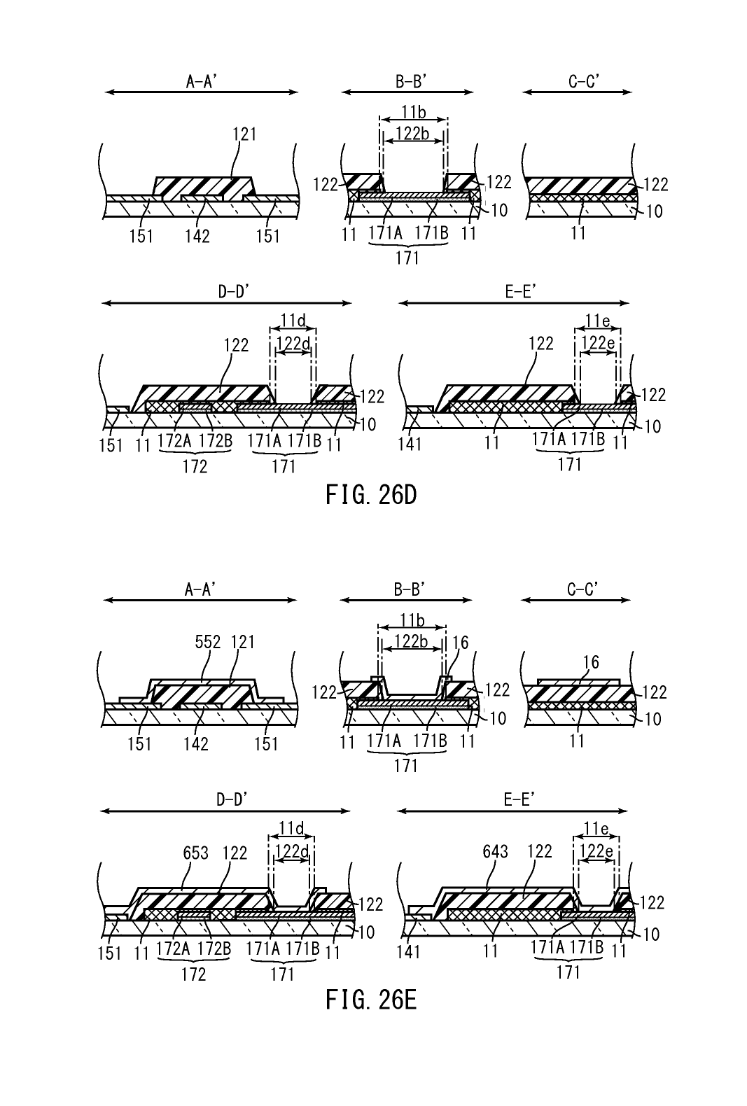

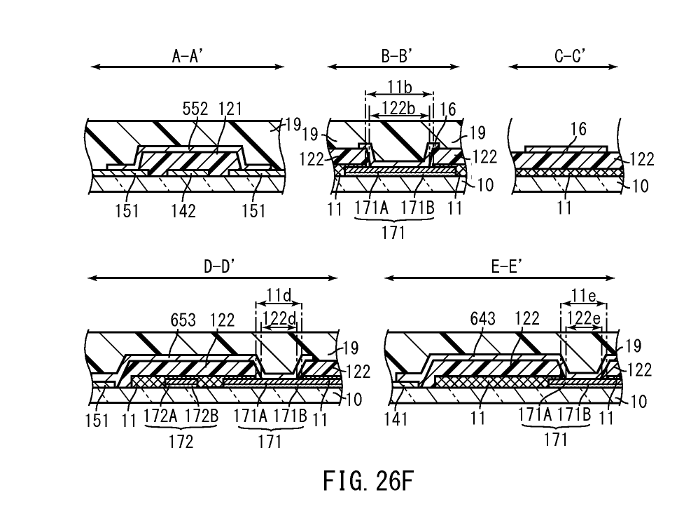

A method of manufacturing the touch panel 6 will be briefly described with reference to FIGS. 26A to 26F. FIGS. 26A to 26F show cross-sections taken along lines A-A′, B-B′, C-C′, D-D′ and E-E′ of FIG. 24.

First, as shown in FIG. 26A, a transparent conductive film (second transparent conductive film) is patterned to form insular electrodes 141 and connecting portions 142 for X electrodes 14 and insular electrodes 151 for Y electrodes 55.

Next, as shown in FIG. 26B, a highly-conductive film is patterned to form lines 171 and a ground line 172. In the present embodiment, too, the highly-conductive film is preferably a laminate including a metal film and a light-shielding conductive film.

Next, as shown in FIG. 26C, a light-shielding film is patterned to form a light-shielding portion 11.

Next, as shown in FIG. 26D, an insulating film is patterned to form interlayer insulating films 121 and a planarizing film 122. In the present embodiment, too, the planarizing film 122 serves to protect the lines 171 and ground line 172. Accordingly, the insulating film is preferably thick. Further, the insulating film is preferably a laminate including an inorganic insulating material and an organic insulating material.

Next, as shown in FIG. 26E, a transparent conductive film (first transparent conductive film) different from that of FIG. 26A is patterned to form connecting portions 552 for the Y electrodes 55, terminals 16 and relay electrodes 643 and 653. The first and second transparent conductive films may be made of the same material or different materials. The first and second transparent conductive films may be formed by the same method or different methods, and may be patterned by the same method or different methods.

Lastly, as shown in FIG. 26F, a protection film 19 is formed.

A construction of the touch panel 6 according to the sixth embodiment of the present invention and a method of manufacturing it have been described.

The touch panel 6 of the present embodiment includes a second transparent conductive layer formed by patterning a second transparent conductive film (i.e. the X electrodes 14 and the insular electrodes 151 of the Y electrodes 55, for example), a highly-conductive layer formed by patterning a highly-conductive layer (i.e. the lines 171, for example), a light-shielding layer formed by patterning a light-shielding film (i.e. the light-shielding portion 11), an insulating layer formed by patterning an insulating film (i.e. the interlayer insulating films 121 and planarizing film 122), and a first transparent conductive layer formed by patterning a first transparent conductive film (i.e. the connecting portions 552 of the Y electrodes 55, for example), formed in this order.

The arrangement of the touch panel 6 also reduces the number of steps compared with the arrangements of the touch panels 9 and 91.

In the touch panel 6, as opposed to the touch panel 5, there is no bridge for the ground line 172. That is, the ground line 172 is not relayed via relay electrodes 18 as in the touch panel 5 (FIG. 21). This reduces the resistance of the ground line 172.

On the other hand, in the touch panel 5, a Y electrode 15 and the corresponding line 171 are in direct contact with each other. That is, there is no need for a contact hole in between as in the touch panel 6. This reduces the resistance of the line 171.

### Seventh Embodiment

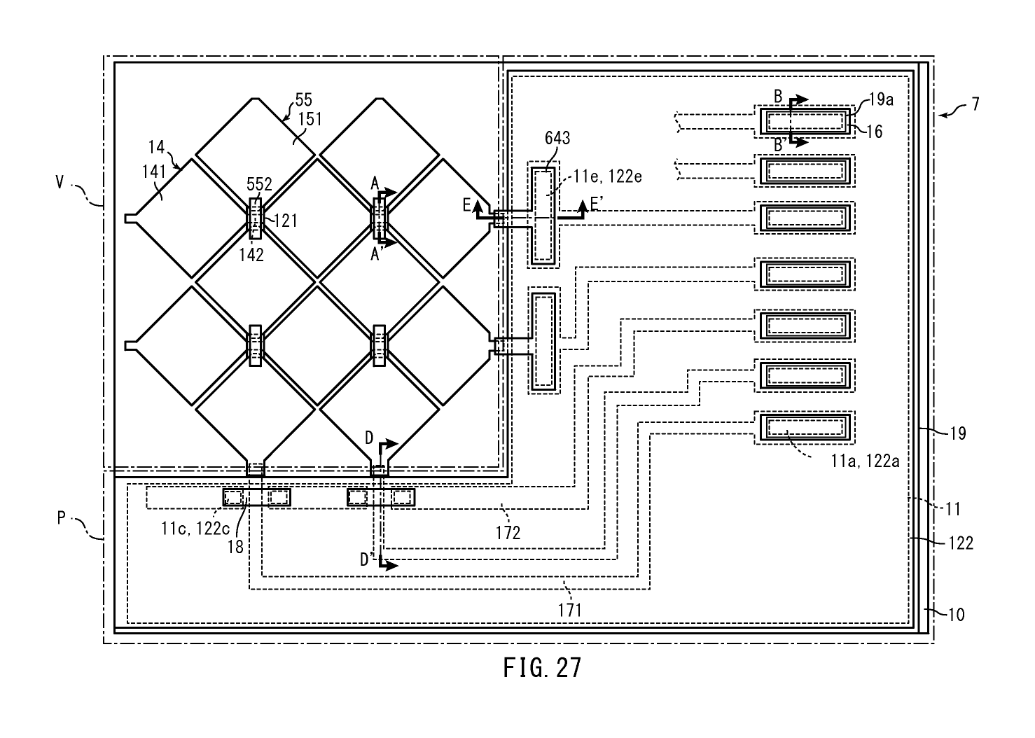

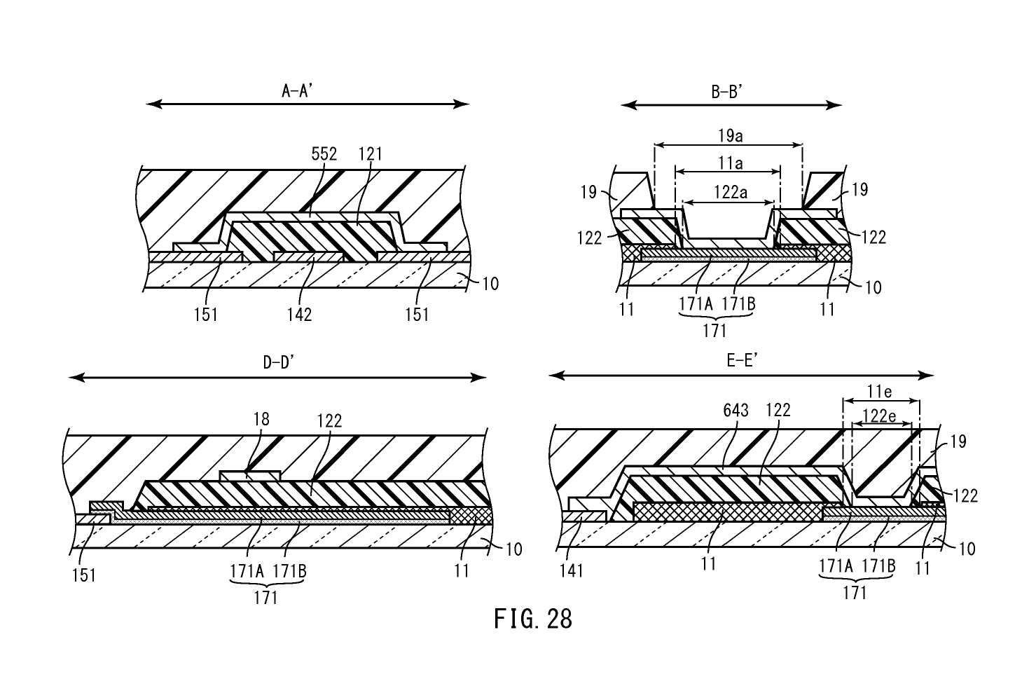

FIG. 27 is a schematic plan view of a touch panel 7 according to a seventh embodiment of the present invention. FIG. 28 shows cross-sections taken along lines A-A′, B-B′, D-D′ and E-E′ of FIG. 27.

The touch panel 7 is different from the touch panel 6 in terms of the construction of the terminals.

Each terminal of the touch panel 7 includes a line 171 or ground line 172 and a terminal 16 formed of a transparent conductive film, deposited in this order. Then, substantially the entire terminals 16 are covered with the protection film 19. In the touch panel 7, a portion of a terminal 16 is exposed via a contact hole 11a formed in the light-shielding portion 11 and a contact hole 122a formed in the planarizing film 122, and, in addition, a contact hole 19a formed in the protection film 19. Then, the terminal 16 is connected with an external drive circuit or the like via the contact holes 11a, 122a and 19a.

In the touch panel 7, the terminals have a lower resistance than those in the touch panel 6.

Further, the touch panel 7 is different from the touch panel 6 in terms of the construction of the connections between lines 171 and the Y electrodes 55. In the touch panel 7, one insular electrode 151 of a Y electrode 55 and the corresponding line 171 are in direct contact with each other.

Further, in the touch panel 7, a relay electrode 18 is provided at the intersection of a line 171 and the ground line 172. The ground line 172 is in contact with the relay electrode 18 via a pair of contact holes 11c formed in the light-shielding portion 11 and a pair of contact holes 122c formed in the planarizing film 122. This arrangement allows the lines 171 to cross the ground line 172 in a plan view without a short circuit.

In the touch panel 7, one insular electrode 151 of a Y electrode 55 and the corresponding line 171 are in direct contact with each other such that the lines 171 have a lower resistance than those of the touch panel 6.

On the other hand, in the touch panel 6, as opposed to the touch panel 7, there is no bridge for the ground line 172. That is, the ground line 172 is not relayed via relay electrodes 18. This reduces the resistance of the ground line 172.

### Eighth Embodiment

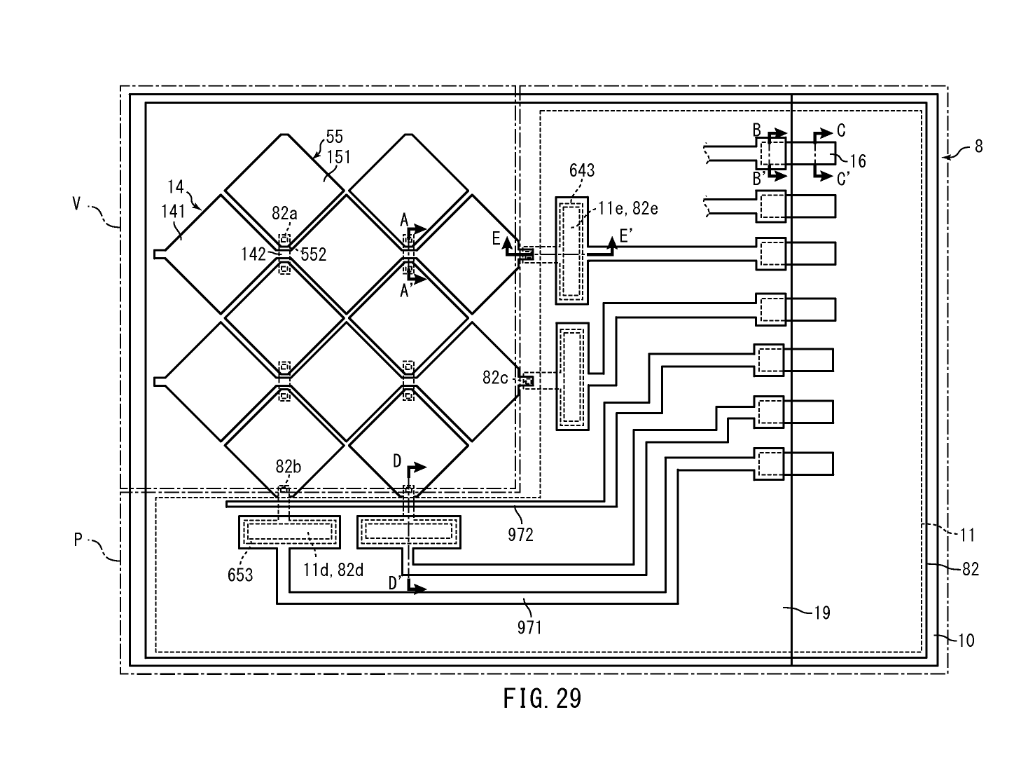

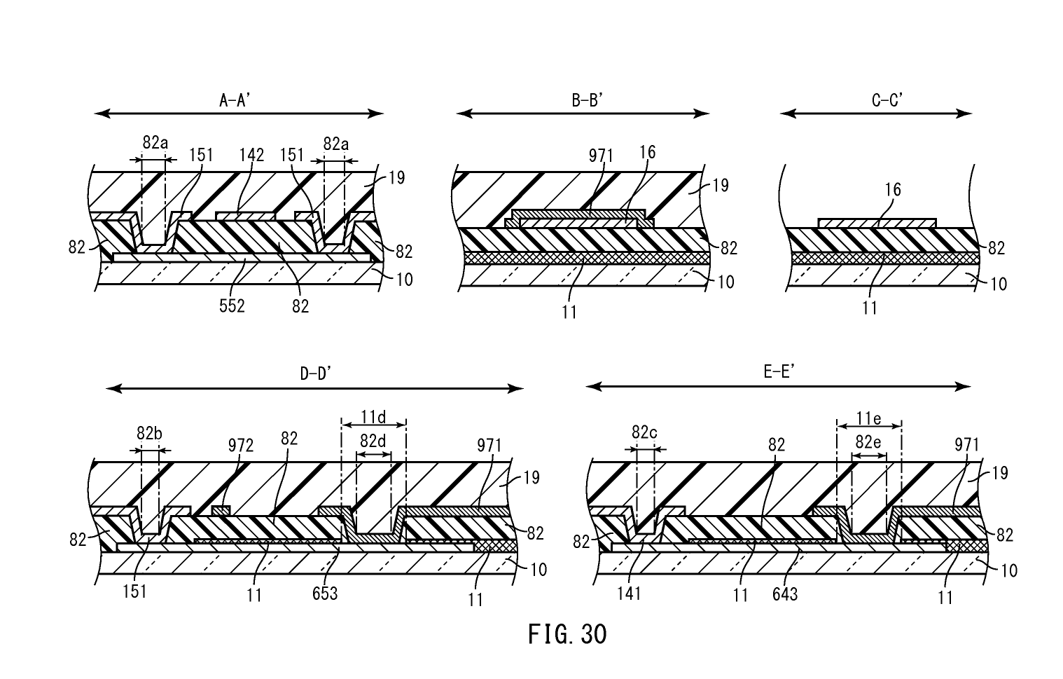

FIG. 29 is a schematic plan view of a touch panel 8 according to an eighth embodiment of the present invention. FIG. 30 shows cross-sections taken along lines A-A′, B-B′, C-C′, D-D′ and E-E′ of FIG. 29.

The touch panel 8 is different from the touch panel 6 (FIG. 24) in terms of the order in which the components are formed. As such, the films are deposited in a different order.

Further, the touch panel 8 includes a planarizing/insulating film 82 instead of the interlayer insulating films 121 and planarizing film 122 of the touch panel 6. The planarizing/insulating film 82 covers substantially the entire surface of the substrate 10, including the connecting portions 552 and light-shielding portion 11. In the present embodiment, the planarizing/insulating film 82 serves as both interlayer insulating films and planarizing film.

In the touch panel 6, an interlayer insulating film 121 is provided at the intersection of an X electrode 14 and a Y electrode 55. On the other hand, in the touch panel 8, a planarizing/insulating film 82 is provided to cover substantially the entire surface of the substrate 10, including the connecting portions 552 of the Y electrodes 55. An insular electrode 151 of a Y electrode 55 is in contact with a connecting portion 552 via a contact hole 82a formed in the planarizing/insulating film 82. This arrangement allows the X electrodes 14 to cross the Y electrodes 55 without a short circuit.

Further, the touch panel 8 includes lines 971 and a ground line 972 instead of the lines 171 and ground line 172 of the touch panel 6. That is, each of the lines 971 and ground line 972 of the touch panel 8 is not a laminate including a metal film and a light-shielding conductive film, but is formed of a metal film.

In the touch panel 8, both the terminals 16 and lines 971 are located in a layer that is more distant from the substrate 10 than the planarizing/insulating film 82 are. As shown in FIG. 30, a terminal 16 is in direct contact with a line 971.

In the touch panel 8, an X electrode 14 is connected with a line 971 via a relay electrode 643. One insular electrode 141 of the X electrode 14 is in contact with the relay electrode 643 via a contact hole 82c formed in the planarizing/insular film 82. The relay electrode 643 is in contact with the line 971 via a contact hole 11e formed in the light-shielding portion 11 and a contact hole 82e formed in the planarizing/insulating film 82.

Similarly, a Y electrode 55 is connected with a line 971 via a relay electrode 653. One insular electrode 151 of the Y electrode 55 is in contact with the relay electrode 653 via a contact hole 82b formed in the planarizing/insulating film 82. The relay electrode 653 is in contact with the line 971 via a contact hole 11d formed in the light-shielding portion 11 and a contact hole 82d formed in the planarizing/insulating film 82.

As shown in FIG. 29, the lines 971 are provided in the non-sensing area P, and are not provided in the sensing area V. The relay electrodes 643, each connecting an X electrode 14 with a line 971, and the relay electrodes 653, each connecting a Y electrode 55 with a line 971, are formed of transparent conductive films. In this arrangement, the lines 971 do not overlie the display region when the sensing area V is placed over the display region of the liquid crystal display device 101. Thus, the lines 971 are not visible. Accordingly, a line need not be a laminate including a metal film and a light-shielding conductive film, as is the case with the lines 171 of the touch panel 6, for example. This simplifies the manufacturing process.

### Method of Manufacturing Touch Panel 8

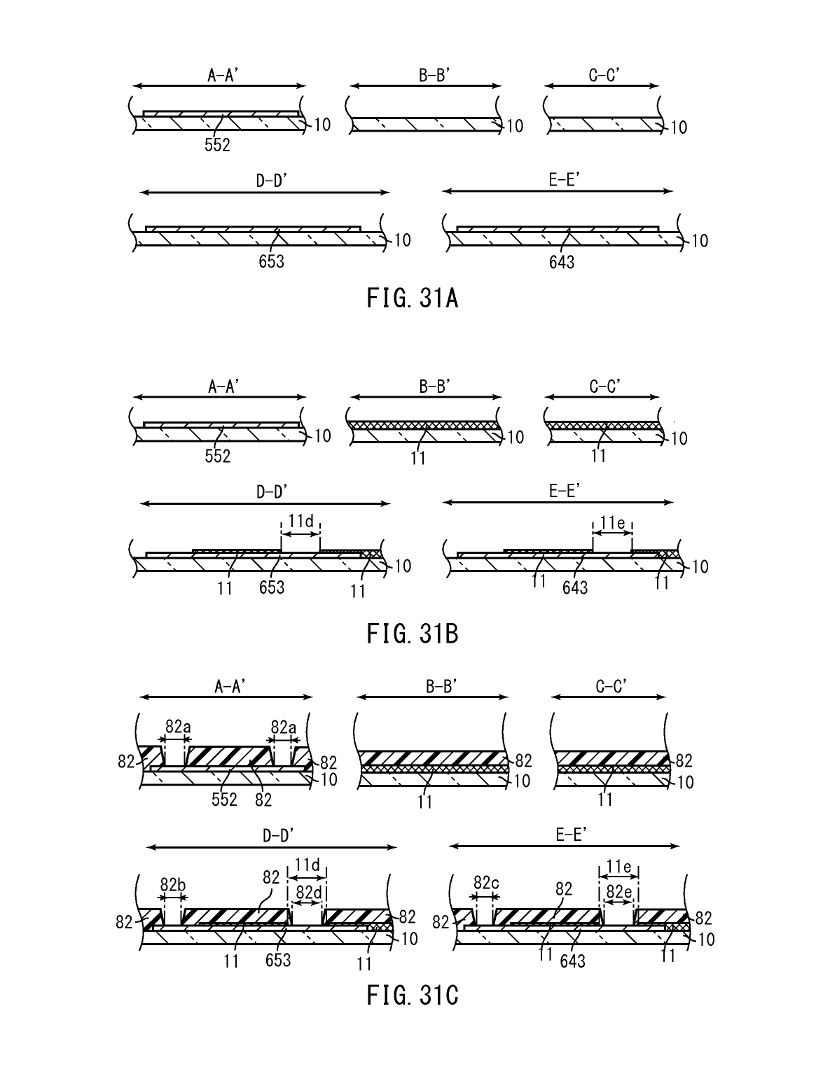

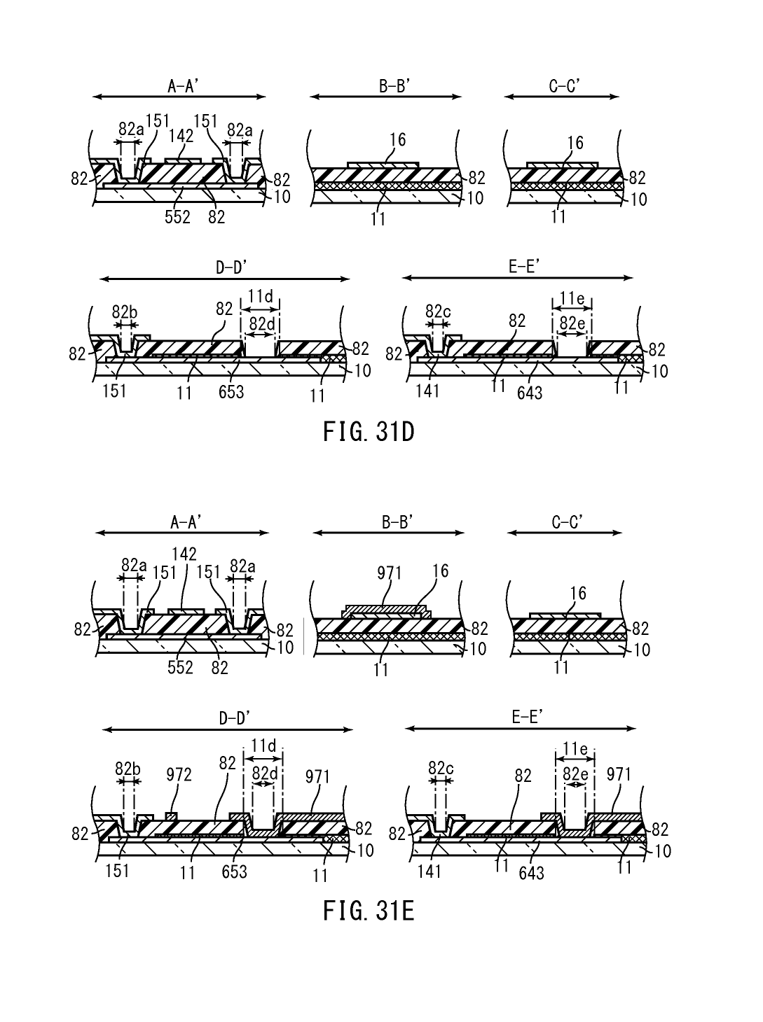

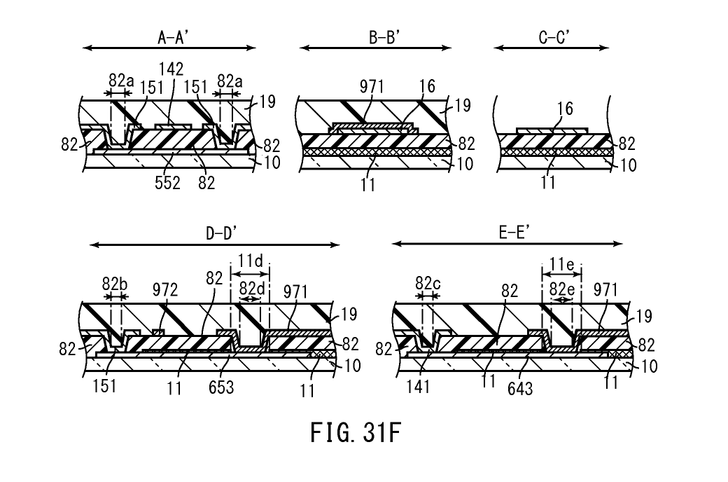

A method of manufacturing the touch panel 8 will be briefly described with reference to FIGS. 31A to 31F. FIGS. 31A to 31F show cross-sections taken along lines A-A′, B-B′, C-C′, D-D′ and E-E′ of FIG. 29.

First, as shown in FIG. 31A, a transparent conductive film (first transparent conductive film) is patterned to form connecting portions 552 for Y electrodes 55 and relay electrodes 643 and 653.

Next, as shown in FIG. 31B, a light-shielding film is patterned to form a light-shielding portion 11.

Next, as shown in FIG. 31C, an insulating film is patterned to form a planarizing/insulating film 82. Similar to the insulating films of the touch panels 1 to 7, the insulating film may be mostly composed of an acrylic resin, novolak resin, epoxy resin, alkyl resin, phenol resin or silicon resin, for example. The patterning may be performed by, for example, a printing method such as screen printing or flexography, an ink-jet technique or photolithography. At the same time as the planarizing/insulating film 82 is formed, contact holes 82a, 82b, 82c, 82d and 82e are formed.

Next, as shown in FIG. 31D, a transparent conductive film (second transparent conductive film) different from that of FIG. 31A is patterned to form insular electrodes 141 and connecting portions 142 for X electrodes 14, insular electrodes 151 for the Y electrodes 55, and terminals 16. The first and second transparent conductive films may be made of the same material or different materials. The first and second transparent conductive films may be formed by the same method or different methods, and may be patterned by the same method or different methods.

Next, as shown in FIG. 31E, a metal film is patterned to form lines 971 and a ground line 972. The metal film (highly-conductive film) has a lower electric resistance than the first transparent conductive film. The metal film may be a laminate film of MoNb, Al and MoNb, for example. In the present embodiment, too, a line may be a laminate including a metal film and a light-shielding conductive film.

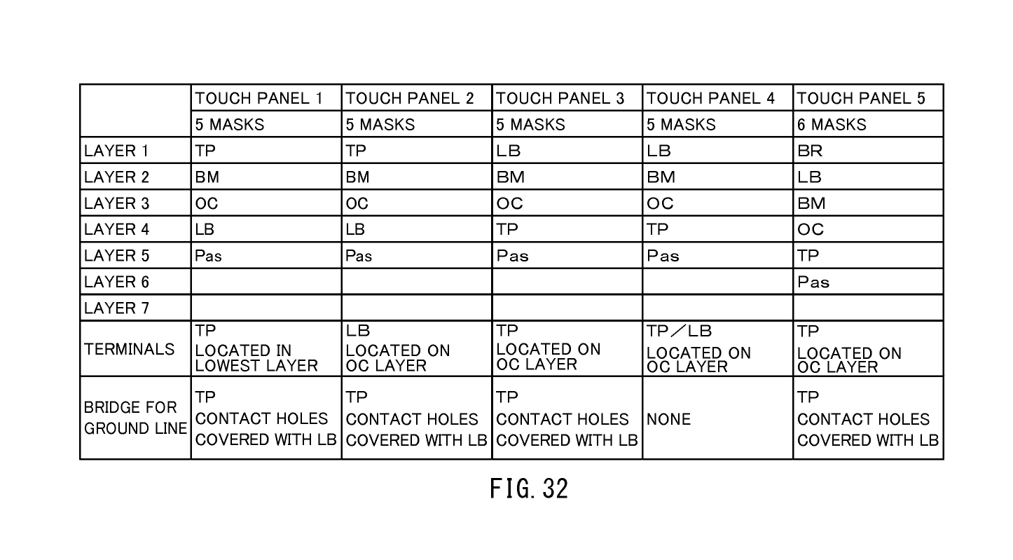

Lastly, as shown in FIG. 32F, a protection film 19 is formed.

A construction of the touch panel 8 according to the eighth embodiment of the present invention and a method of manufacturing it have been described.

The touch panel 8 of the present embodiment includes a first transparent conductive layer formed by patterning a first transparent conductive film (i.e. the connecting portions 552 of the Y electrodes 55, for example), a light-shielding layer formed by patterning a light-shielding film (i.e. the light-shielding portion 11), an insulating layer formed by patterning an insulating film (i.e. the interlayer insulating films 121 and planarizing film 122), a second transparent conductive layer formed by patterning a second transparent conductive film (i.e. the X electrodes 14 and the insular electrodes 151 of the Y electrodes 55, for example), and a highly-conductive layer formed by patterning a metal film (i.e. the lines 971, for example), formed in this order.

The arrangement of the touch panel 8 also reduces the number of steps compared with the arrangements of the touch panels 9 and 91.

### Other Embodiments

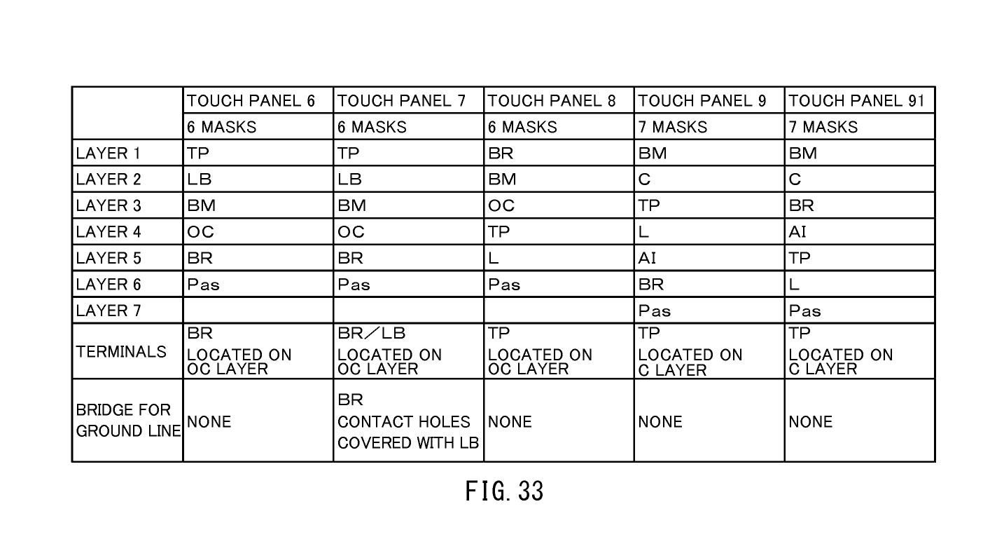

The first to eighth embodiments of the present invention have been described. The constructions of the embodiments are listed in FIGS. 32 and 33.

In FIGS. 32 and 33, an entry for each of “Layer 1”, “Layer 2” etc. shows the construction of the corresponding one of the associated layers, numbered in the order away from the substrate 10. “TP” denotes a transparent conductive layer including the insular electrodes 141 and 151. “BM” denotes a light-shielding layer, “OC” an insulating layer, “LB” a highly-conductive layer (i.e. a layer including a metal film and a light-shielding conductive film), “L” a highly-conductive layer (i.e. a layer made of a metal film), “BR” a transparent conductive layer including the connecting portions 552, and “Pas” a layer including the protections film 19. For the touch panels 9 and 91, “C” denotes a layer including the planarizing film 92, and “AI” a layer including the interlayer insulating films 931 and 932.

An entry for “Terminals” shows which of the above layers forms the terminals. “TP/LB” indicates that a transparent conductive layer including the insular electrodes 141 and 151 is deposited on top of a highly-conductive film. “BR/LB” indicates that a transparent conductive layer including the connecting portions 552 is deposited on top of a highly-conductive film.

An entry for “Bridge for Ground Line” shows in which of the above layers the ground line 172 or 971 is relayed.

The present invention is not limited to the above embodiments, and various modifications and combinations are possible within the scope of the invention.

### INDUSTRIAL APPLICABILITY

The present invention is industrially useful in a touch panel and a method of manufacturing a touch panel.

1. A method of manufacturing a touch panel including:
sensor electrodes including a first electrode and a second electrode crossing each other in a plan view;
an interlayer insulating film insulating the first electrode and the second electrode from each other;
lines each electrically connected with one of the sensor electrodes;
a light-shielding portion overlying the lines in a plan view; and
a planarizing film covering the light-shielding portion, the method comprising the steps of:
patterning a first transparent conductive film to form a layer containing parts of the sensor electrodes;
patterning a highly-conductive film having a lower electric resistance than the first transparent conductive film to form a layer containing the lines;
patterning a light-shielding film to form a layer containing the light-shielding portion; and,
after forming the layer containing the light-shielding portion, pattering an insulating film to form a layer containing the interlayer insulating film and the planarizing film,
wherein the step of patterning a light-shielding film and the step of patterning an insulating film are performed between the step of pattering a first transparent conductive film and the step of patterning a highly-conductive film.

2. The method of manufacturing a touch panel according to claim 1, wherein the highly-conductive film includes a metal film and a light-shielding conductive film having a higher optical absorptance than the metal film.

3. The method of manufacturing a touch panel according to claim 2, wherein the light-shielding conductive film is an indium oxide film.

4. The method of manufacturing a touch panel according to claim 1, wherein other parts of the sensor electrodes are formed from the highly-conductive film.

5. The method of manufacturing a touch panel according to claim 4, wherein the step of patterning a first transparent conductive film, the step of patterning a light-shielding film, the step of patterning an insulating film and the step of patterning a highly-conductive film are performed in this order.

6. The method of manufacturing a touch panel according to claim 4, wherein the step of patterning a highly-conductive film, the step of patterning a light-shielding film, the step of patterning an insulating film and the step of patterning a first transparent conductive film are performed in this order.

7. The method of manufacturing a touch panel according to claim 1, further comprising the step of patterning a second transparent conductive film,
wherein other parts of the sensor electrodes are formed from the second transparent conductive film.

8. The method of manufacturing a touch panel according to claim 7, wherein the step of patterning a second transparent conductive film, the step of patterning a highly-conductive film, the step of patterning a light-shielding film, the step of patterning an insulating film and the step of patterning a first transparent conductive film are performed in this order.

9. The method of manufacturing a touch panel according to claim 8, wherein the second electrode includes a plurality of insular electrodes and connecting portions each connecting two adjacent insular electrodes,
the first electrode and insular electrodes are formed from the first transparent conductive film, and
the connecting portions are formed from the second transparent conductive film.

10. The method of manufacturing a touch panel according to claim 8, wherein the second electrode includes a plurality of insular electrodes and connecting portions each connecting two adjacent insular electrodes,
the first electrode and insular electrodes are formed from the second transparent conductive film, and
the connecting portions are formed from the first transparent conductive film.

11. The method of manufacturing a touch panel according to claim 7, wherein the step of patterning a first transparent conductive film, the step of patterning a light-shielding film, the step of patterning an insulating film, the step of patterning a second transparent conductive film and the step of patterning a highly-conductive film are performed in this order.

12. A touch panel including sensor electrodes including a first electrode and a second electrode crossing each other in a plan view, comprising:
a first transparent conductive layer formed by patterning a first transparent conductive film;
a highly-conductive layer formed by patterning a highly-conductive film having a lower electric resistance than the first transparent conductive film;
a light-shielding layer formed by patterning a light-shielding film; and
an insulating layer formed by patterning an insulating film,
wherein the first transparent conductive layer contains parts of the sensor electrodes, and
the light-shielding layer and the insulating layer are located between the first transparent conductive layer and the highly-conductive layer.

13. The touch panel according to claim 12, wherein the highly-conductive film includes a metal film and a light-shielding conductive film having a higher optical absorptance than the metal film.

14. The touch panel according to claim 13, wherein the light-shielding conductive film is an indium oxide film.

15. The touch panel according to claim 12, wherein the highly-conductive layer contains other parts of the sensor electrodes.

16. The touch panel according to claim 12, further comprising: a second transparent conductive layer formed by patterning a second transparent conductive film,
wherein the second transparent conductive layer contains other parts of the sensor electrodes.
